(19) United States
(12) Patent Application Publication
(10) Pub. No.: US 2026/0230005 A1
(43) Pub. Date: Aug. 6, 2026

(54) BI-DIRECTIONAL AC TO DC RECTIFIER

(71) Applicant: DIGIQ POWER LTD., Kingston (CA)

(72) Inventors: Yan-Fei LIU, Kingston (CA); Binghui HE, Kingston (CA); Yang CHEN, Kingston (CA)

(21) Appl. No.: 19/032,371

(22) PCT Filed: May 31, 2024
(86) PCT No.: PCT/CA2024/050734

§ 371 Date: Jan. 20, 2025

Related U.S. Application Data
(60) Provisional application No. 63/543,725, filed on Oct. 11, 2023.

(51) Int. Cl. H02M 7/797; H02J 7/06; H02M 1/14; H02M 1/42

(52) U.S. Cl. CPC H02M 7/797; H02J 7/06; H02M 1/14; H02M 1/4258; H02J 2207/20

(57) ABSTRACT

Proposed circuit architectures are described that includes a first AC-DC power stage that can be used bi-directionally, operating in both forward and reverse modes. The circuit is configured for PFC operation where the input current is required to be sinusoidal in phase with the input voltage. A ripple cancellation converter can be connected in series with the output of the first AC-DC power stage. The AC-DC power stage includes a number of switched gates that are controlled for coordinated bi-directional operation. As described herein, a technical benefit of the first AC-DC power stage is a proposed reduction in a need for a large capacitor, which assists in reducing losses and increasing efficiency.

### CROSS-REFERENCE

This application is a non-provisional of, and claims all benefits, including priority to, U.S. Application No. 63/543,725, filed Oct. 1, 2023, entitled “Bi-directional AC to DC rectifier”, incorporated by reference in its entirety.

### FIELD

Embodiments of the present disclosure generally relate to the field of electronics, and more specifically, embodiments relate to devices, systems and methods of operating a bi-directional charger.

### INTRODUCTION

Bi-directional electric vehicle chargers are desirable, providing flexibility in usage scenarios where a grid is not only providing power to an electric vehicle to charge a battery, but also the battery of the electric vehicle can now also be utilized as part of an energy storage infrastructure that can be used for emergency power (e.g., loss of grid power to the house, vehicle battery is used as a temporary power source), or it can be used as part of an overall energy storage mechanism using a large number of electric vehicles or other household large scale batteries for load management.

For example, a grid having a large amount of renewable sources may utilize bi-directional charging to store a large amount of energy during periods of plentiful power (e.g., high winds, high solar), and use the bi-directional capability to provide energy back to the grid during periods of less plentiful power (e.g., during load spikes, low wind, or at night).

As described herein, bi-directional means that there are two modes: forward operation mode, when the grid is charging the electric vehicle, and backward operation mode (vehicle to grid), when the battery is being discharged to provide electric energy to the grid. An example of practical situation for using bi-directional charging could be when there is a major grid failure. For example, during a major blackout situation, as an emergency option, a grid could changeover to request energy from electric vehicles.

### SUMMARY

Proposed circuit architectures are described that includes a first AC-DC power stage that can be used bi-directionally, operating in both forward and backward (or reverse) modes. The circuit is configured for PFC operation where the AC input current is required to be sinusoidal in phase with the input AC voltage. A ripple cancellation converter can be connected in series with the output of the first AC-DC power stage.

The circuit is configured for operation in an “active bridge” mode or a “boost” mode, based on the sensed input voltage. The circuit can change between the two modes based at least on a measured property of the sensed input voltage. For example, operation in the active bridge mode can be utilized when the input voltage is at a target nominal voltage or higher than the nominal voltage, while operation in the boost mode can be utilized when the input voltage is below the nominal voltage, effectively boosting the voltage to the nominal voltage. As described in further detail herein, the circuit can thus help improve efficiency of a downstream circuit stage. The technical tradeoff of this approach is that the boost mode operation may incur switching losses at this first stage.

The first AC-DC power stage can be considered as a two-stage configuration, having a front-stage totem-pole bridgeless rectifier and back-stage LLC converter. The front-stage totem-pole bridgeless rectifier is responsible for rectifying the sinusoidal input voltage Vac into a half-wave sinusoidal voltage, Vrec1, with a fixed peak voltage. An important advantage of the proposed first AC-DC power stage is that a small value of a capacitor, Cin1, is possible due to the specific operation of the topology. The small value of Cin1, for example, in the order of 10 microfarads, allows for more flexibility in component selection and power ratings. It is noted that Cin1 is connected at the output of the front stage totem-pole bridgeless rectifier. It is used to filter out the switching frequency ripple. It does not store energy and therefore, a small value, such as 10 microfarads (10 uF), can be used.

The back-stage LLC converter is responsible for fully absorbing the instantaneous input power Pac to achieve the PFC functionality of the front-stage. In other words, the AC input current is controlled by the back-stage LLC converter. It is noted that other topologies, such as Isolated Boost converter, Dual Active Bridge (DAB) converter, CLLC converter, can also serve as the back-stage converter. In this application, the LLC converter is used as an example of the back-stage converter.

While the first AC-DC power stage can be used as a standalone circuit, its power handling capacity is limited in the forward operation. Accordingly, in a variant embodiment, the first AC-DC power stage is utilized in combination with one or more other circuit segments, denoted as Phase 1 and Phase 2 herein. This is useful for higher power applications, while the standalone embodiment of the first AC-DC power stage can be used as a cost-effective solution for low-medium power applications.

Accordingly, in a variant embodiment, Phase 2 or additional phases can be coupled to add additional power during the forward operation (when the AC power is converted to DC). In this example, for example, when there is a desire to charge the battery of the electric vehicle, 6.6 kW may be requested, such that Phase 2 or additional phases are used for providing full power output in the forward direction. However, in backwards operation (when battery DC power is converted to AC, or battery discharging), the typical power request is not as high, and in an embodiment, only Phase 1 operates, providing lower power, such as 2.2 KW or 3.3 KW in the reverse direction.

By reducing the capacitance value of Cin1, the circuit is able to operate more efficiently relative to other designs, which helps improve power delivery, especially under full load efficiency considerations. For example, if efficiency is able to be boosted to approximately 99-99.5% (as compared to other designs having a larger Cin1 value at around an efficiency of 98%), there are significant cost savings, as well as less excess heat generated as a result of the reduced losses. This heat reduction is an important consideration when designing charging devices because overheating issues can cause safety related shutdowns or reduced charging speeds. Accordingly, the proposed design can assist with reducing the propensity of overheating situations.

The proposed approaches can be practically implemented in a variety of different devices, such as a circuit module or circuit system that is configured for placement on-board a vehicle, or a system that is coupled to a charging station that the electric vehicle couples to. Another variation includes coupling the charger circuit as part of a drivetrain, which is provided as part of the electric vehicle.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1A is a block diagram showing the architecture of an exemplary bidirectional EV charger.

FIG. 1B is a two-dimensional graph illustrating voltage as a function of time.

FIG. 2A is a block diagram illustrating the circuit topology for the isolated AC-DC stage shown in FIG. 1A, according to some embodiments.

FIG. 2B is a block diagram illustrating the circuit topology for the isolated AC-DC stage shown in FIG. 1A with Phase 2 removed, showing an alternate embodiment where only a standalone AC-DC stage is used.

FIG. 3A is a block diagram illustrating a circuit topology for the RCC converter shown in FIG. 1A, where the input of RCC is connected to Vmain and the output of the RCC circuit is connected in series with Vmain and the combined output (Vmain in series with the output voltage of RCC) is connected to the battery (load).

FIG. 3B is a block diagram illustrating a circuit topology for the RCC converter shown in FIG. 1A, where the terminals of RCC are configured opposite relative to FIG. 3A, as an alternate embodiment, and a control architecture used to control the forward operation of the RCC converter shown in FIG. 3A, where the battery is in a constant current charging state.

FIG. 4A is a block diagram illustrating the PSIM simulation model of the totem-pole bridgeless rectifier.

FIG. 4B is a block diagram illustrating the PSIM simulation model of the totem-pole bridgeless rectifier with more detailed information for the gate drive signals operating at Boost Mode for these four switches. It is also noted that the output capacitor, Cin1, is 10 uF, which is used only for output voltage ripple filtering of the switching frequency, not for energy storage.

FIG. 4C illustrates two-dimensional graphs showing the waveforms of the totem-pole bridgeless rectifier shown in FIG. 2B when the peak voltage of Vrec1 is regulated to be slightly higher than the peak voltage of Vac.

FIG. 4D illustrates two-dimensional graphs showing the waveforms of the totem-pole bridgeless rectifier shown in FIG. 2B operating at Active Bridge mode when the peak voltage of Vrec1 is the same as the peak voltage of Vac.

FIG. 5 is a two-dimensional graph showing simulation waveforms of Vac, Vrec1, Lac inductor current I(Lac), and the instantaneous output power which is represented by I(R_load)*V(R_load), the load current times the output voltage, operating at Boost Mode.

FIG. 6A is a block diagram illustrating the complete PSIM simulation model of the forward operation of the isolated AC-DC stage shown in FIG. 2B.

FIG. 6B is a block diagram illustrating the complete PSIM simulation model of the forward operation of the isolated AC-DC stage shown in FIG. 2B, where more implementation details are provided.

FIG. 6C is a block diagram illustrating sensing the AC input current and controlling the LLC converter to achieve input power factor correction.

FIG. 7A is a two-dimensional graph showing simulation waveforms of the circuit as shown in FIG. 6B, where I(Lac) is the current through the inductor Lac, Vac is the AC input voltage, Irec1 is the output current of the front-stage. Vrec1 is the output voltage of the front-stage, I(Lr1) is the resonant current of the back-stage, an LLC converter as shown in FIG. 6B, and Vmain is the output voltage of the back-stage converter, Vo_LLC.

FIG. 7B is a two-dimensional graph showing simulation waveforms of the circuit as shown in FIG. 6B, with waveforms more easily observed.

FIG. 8A is a two-dimensional graph showing waveforms of the backward operation (battery discharging operation) of the isolated AC-DC stage shown in FIG. 2B, wherein Vrec1 is controlled to be a full-wave rectified sinusoidal voltage.

FIG. 8B is a two-dimensional graph showing waveforms of the backward operation (battery discharging operation) of the LLC converter shown in FIG. 2B, wherein Vrec1 is controlled to form a full-wave rectified sinusoidal voltage.

FIG. 9A is a two-dimensional graph showing the waveforms of the backward operation when Vrec1 is controlled to be a DC voltage.

FIG. 9B is a two-dimensional graph showing waveforms of the backward operation of the isolated AC-DC stage shown in FIG. 2B, wherein Vrec1 is controlled to maintain a constant DC voltage Vrec1_const, where Vrec1_const is larger than the peak AC voltage value, Vac_peak.

FIG. 10 is a two-dimensional graph showing waveforms of the backward operation of the isolated AC-DC stage shown in FIG. 2B, wherein Vrec1 is controlled to be a full-wave rectified sinusoidal voltage with the lowest voltage limited to Vrec1_min.

FIG. 11 is a block diagram illustrating a control architecture used to control the backward operation of the isolated AC-DC stage shown in FIG. 2B, wherein Vrec1 is controlled to maintain a constant DC voltage.

FIG. 12 is a block diagram illustrating a control architecture used to control the backward operation of the isolated AC-DC stage shown in FIG. 2B, wherein Vrec1 is controlled to maintain a constant DC voltage, and the RCC converter is enabled.

FIG. 13 illustrates two-dimensional graphs showing the waveforms of the full bridge inverter, LLC converter, and RCC converter as shown in FIG. 12.

### DETAILED DESCRIPTION

Proposed circuit architectures are described that includes a first AC-DC power stage that can be used bi-directionally, operating in both forward and backward modes. The forward mode operation is defined as converting the AC input voltage to a DC voltage that is used to charge the battery (or other energy storage component, such as super capacitor). The backward mode operation is defined as converting the battery voltage (which is a DC voltage) into an AC voltage. This AC voltage can be connected to the grid. This AC voltage can also be used to power any AC load directly without connecting to the AC grid. During forward mode operation, the circuit is configured for PFC (Power Factor Correction) operation where the input current is required to be sinusoidal in phase with the input voltage.

The circuit is configured for operation in an “active bridge” mode or a “boost” mode, based on the sensed input voltage. The sensed input voltage can be measured using a physical voltage sensor circuit, described in further detail below (e.g., input AC voltage sensing circuit, based on a voltage error signal for comparison and controlled using a voltage loop controller circuit).

In boost mode, the peak voltage of Vrec1 may be controlled to be slightly higher than the peak voltage of Vac. In active bridge mode, the peak voltage of Vrec1 may be regulated to be the same as the peak voltage of Vac.

The reason for this is that operating in boost mode helps improve the efficiency of the overall circuit, as noted below, when the sensed input voltage is measured to be low. Accordingly, the circuit can change between the two modes based at least on a measured property of the sensed input voltage. A control circuit is provided that is configured to toggle the operation between the different modes, and this can be conducted automatically in an effort to increase overall efficiency automatically by switching the operating paradigm. This allows the circuit to operate with improved efficiency based on where losses dominate, using the appropriate control method.

For example, operation in the active bridge mode can be utilized when the input voltage is at or higher than a target nominal voltage, while operation in the boost mode can be utilized when the input voltage is below the nominal voltage, effectively boosting the voltage to the nominal voltage. As described in further detail herein, the circuit can thus help improve efficiency of a downstream circuit stage by selectively using the boost mode operation. The technical tradeoff of this approach is that the boost mode operation may incur switching losses at this first stage. The active bridge mode suffers less losses at this stage than the boost mode operation as it does not require the high-frequency switching.

A Ripple Cancellation Converter (RCC) can be connected in series with the output of the first AC-DC power stage. Variations of how the RCC is connected are possible, and shown in variant embodiments herein.

The AC-DC power stage includes a number of switched gates that are controlled for coordinated bi-directional operation. As described herein, a technical benefit of the first AC-DC power stage is a proposed reduction in a need for a large capacitor, which assists in reducing losses and increasing system power density.

A number of variations are also proposed using multiple phases of the circuit (albeit potentially lower cost phases) to aid in forward operation mode, the usage of the circuit as a standalone circuit without additional phases, as well as control approaches for controlling the gate operation. In some embodiments, an additional controller circuit is coupled to the gates for timed operation of the gates in accordance with one or more duty cycles or switching frequencies.

The system can be practically implemented in various charging scenarios where bi-directional charging is desirable, and while electric vehicles (EV) are described as an illustrative non-limiting example, the approach can also be utilized in combination with any energy storage device, such as super capacitors, household power banks, portable power stations (such as those that can be brought along in a vehicle during a camping trip), among others.

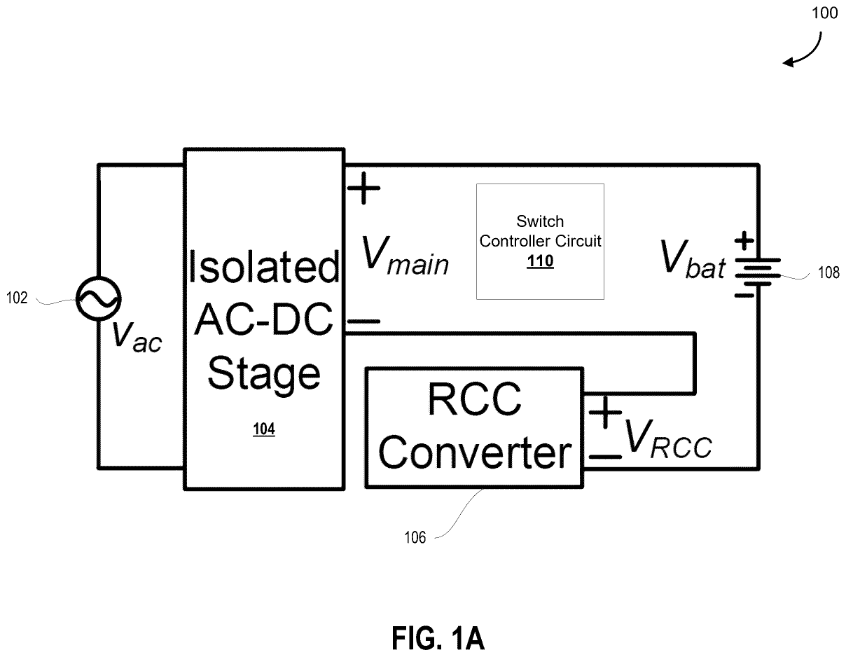

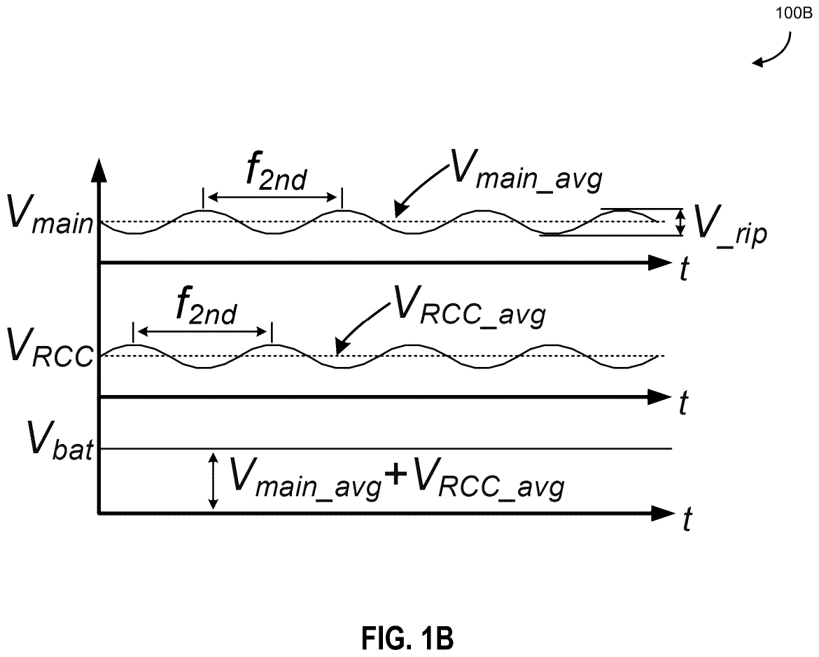

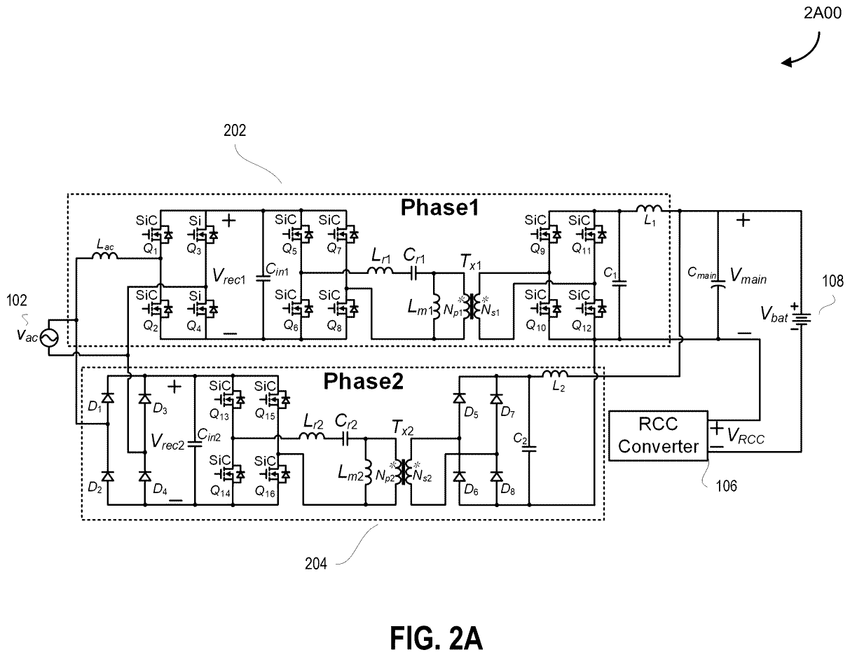

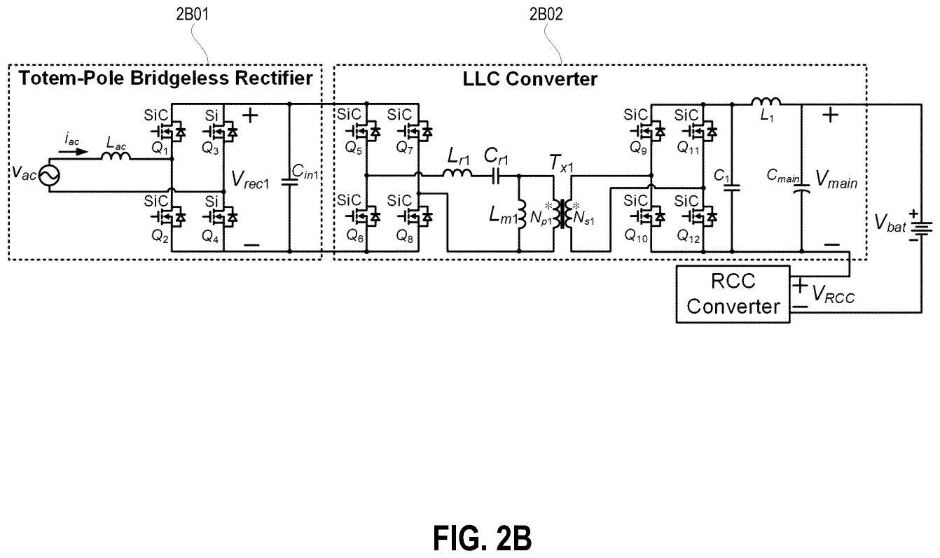

FIG. 1A is a diagram 100 that shows the architecture of the proposed bidirectional EV charger. A system is shown that is coupled to an AC voltage (e.g., a grid) 102. There is an isolated AC-DC stage 104, shown in greater detail in FIG. 2A. It couples with an energy storage, shown as an example as Vbat 108. As described herein, the energy storage does not necessarily need to be a battery and other types of energy storage are contemplated. During forward operation (AC to DC), the AC voltage 102 may originate from the grid. During backward operation (DC to AC), the AC voltage 102 can either be connected to the grid (grid-connected mode) or provided by the isolated AC-DC stage 104 (off-grid mode). A switch controller circuit 110 is employed to control the bidirectional operation of the proposed EV charger.

During forward operation (AC to DC rectifier with Power Factor Correction), an RCC (Ripple Cancellation Converter) converter 106 is connected in series with the output of an isolated AC-DC converter.

The output of the isolated AC-DC converter is denoted by Vmain, which contains voltage ripple at double line frequency f_{2nd} which is 120 Hz in North America and 100 Hz in Europe, China, as shown in FIG. 1B.

To eliminate the double line frequency ripple on Vmain, the RCC converter is used to generate the same magnitude but 180-degree phase shifted ripple voltage V_{RCC}, as shown in FIG. 1B. As shown in graph 100B of FIG. 1B, the ripple of Vbat is reduced or practically eliminated.

Thus, AC-DC control loop and RCC control loop are decoupled. During backward mode (DC to AC inverter) operation, the output of the RCC converter can be short-circuited. Vbat directly applies to the isolated AC-DC stage, which operates as a DC to AC inverter to generate AC sinusoidal voltage Vac.

FIG. 2A illustrates a proposed circuit topology for the isolated AC-DC stage shown in FIG. 1A, according to some embodiments. The circuit topology depicted comprises two circuit segments, Phase 1 202 and Phase 2 204, and it is important to note that some proposed embodiments herein only have Phase 1 operating independently (see FIG. 2B).

During forward operation, both Phase 1 and Phase 2 operate to achieve full power output. During backward operation, as its rated power is only half that of forward operation, only Phase 1 operates. Therefore, Phase 1 is designed to operate bidirectionally, while Phase 2 can only operate in the forward direction.

For low-to-medium power applications, Phase 2 in FIG. 2A may be removed, as depicted in FIG. 2B. The isolated AC-DC stage operates in both forward and backward modes. Since the circuit operates in single-phase mode during forward operation, its power handling capacity is half that of the circuit topology illustrated in FIG. 2A.

Additionally, due to the reduced number of power electronic devices, this circuit significantly lowers component costs. Therefore, it presents a more cost-effective solution for low-to-medium power applications.

For medium to high power applications, Phase 2 or additional phases can be added. Accordingly, in a variant embodiment, Phase 2 or additional phases can be coupled to add additional power during the forward operation. In this example, for example, when there is a desire to charge the battery of the electric vehicle, 6.6 KW may be requested, such that Phase 2 or additional phases are used for providing full power output in the forward direction. However, in backward operation, the typical power request is not as high, and in an embodiment, only Phase 1 operates, providing lower power to AC side, such as 2.2 KW or 3.3 KW, in the reverse direction. While the first AC-DC power stage can be used as a standalone circuit, its power handling capacity is limited in the forward operation. Accordingly, in a variant embodiment, the first AC-DC power stage is utilized in combination with one or more other circuit segments, denoted as Phase 1 and Phase 2 herein. This is useful for higher power applications, while the standalone embodiment of the first AC-DC power stage can be used as a cost-effective solution for low-medium power applications.

The Phase 2 circuits are lower cost relative to Phase 1, as they can effectively utilize diode rectifiers, including D1, D2, D3, D4, D5, D6, D7, and D8, as depicted in FIG. 2A.

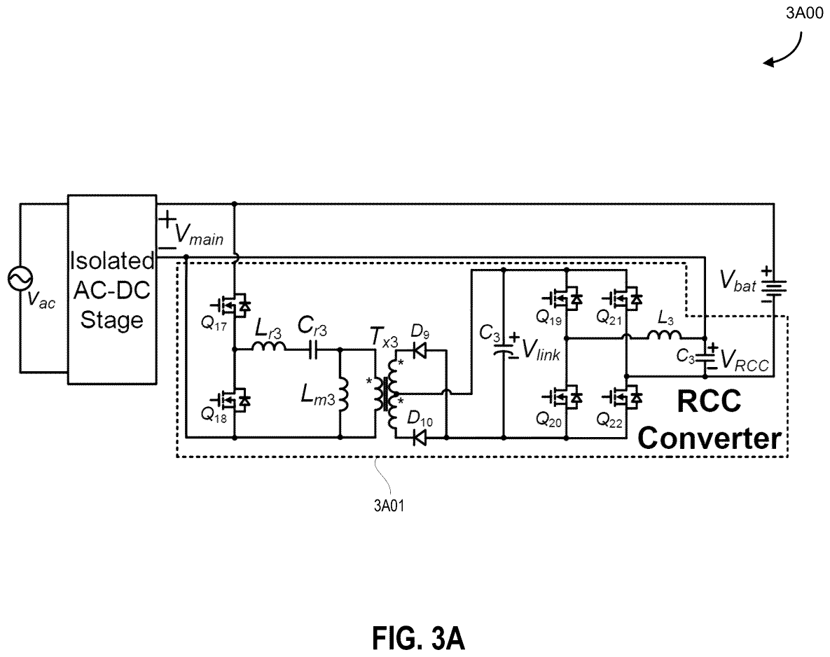

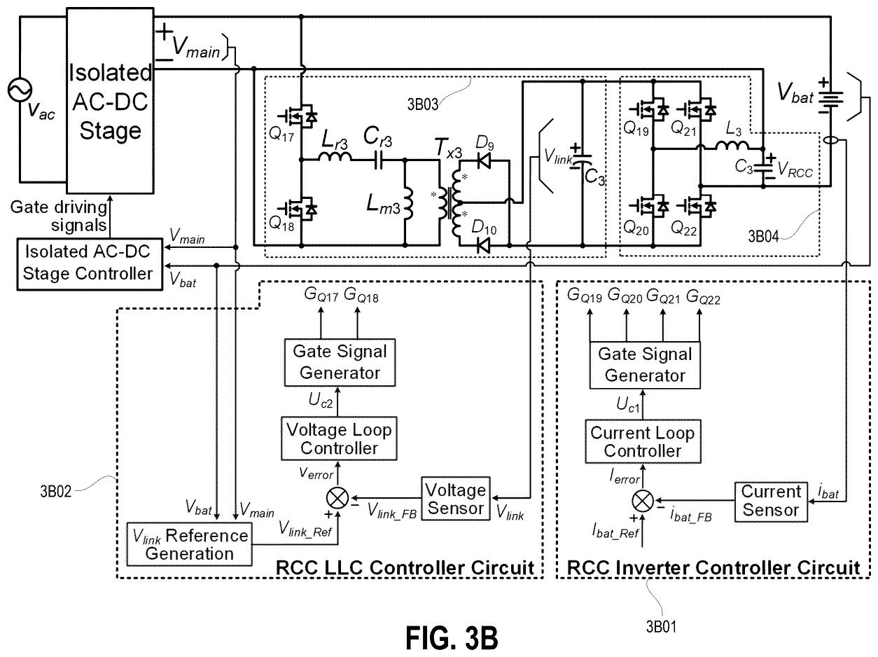

FIG. 3A and FIG. 3B are an illustration 300 of the circuit topology for the RCC converter 106 shown in FIG. 1A. It comprises an isolated half-bridge LLC converter in the first stage (shown as box 3B03 in FIG. 3B) and a full-bridge inverter circuit in the second stage (shown as box 3B04 in FIG. 3B). The input voltage is taken from Vmain and reduced to Vlink by the isolated half-bridge LLC converter. The full-bridge inverter circuit in the second stage is responsible for converting the DC voltage Vlink into a sinusoidal voltage, VRCC. It is noted that VRCC is basically an AC voltage, with zero or very small DC value. The AC voltage has the same amplitude and reverse polarity as the ripple voltage of Vmain, as shown in FIG. 1B.

FIG. 3B is a block diagram illustrating a control architecture used to control the forward operation of the RCC converter shown in FIG. 3A, where the battery is in a constant current charging state

### Forward Operation

In forward operation, power is delivered from the AC grid to the DC battery side. While a DC battery is described, other types of power storage are possible and contemplated, such as an electric vehicle having a capacitor or super capacitor that is used as an energy storage device.

### 1) Forward Operation of Phase 1:

For the forward operation, as shown in FIG. 2B, it can be treated as a two-stage configuration, including front-stage totem-pole bridgeless rectifier and back-stage LLC converter. It is noted that the back-stage LLC converter can be replaced with other isolated bidirectional DC-DC converters, including but not limited to series resonant converters, CLLC converters, CLLLC converters, dual active bridge (DAB) converters, and dual active bridge series resonant converters. Here, the LLC converter is used as an example to illustrate the forward operation.

This application proposes that the front-stage totem-pole bridgeless rectifier is used to rectify the sinusoidal input voltage Vac into a half-wave sinusoidal voltage, Vrec1, with a fixed peak voltage, Vrec1_peak. It is noted that the conventional totem-pole bridgeless rectifier converts the AC input into a voltage that is basically a DC voltage, with small AC ripple. Depending on the design, it is desirable to set the peak-to-peak value of the AC ripple to about 2 to 20 percent of the DC voltage value.

In one embodiment, the peak voltage of Vrec1 may be controlled to be slightly higher than the peak voltage of Vac. In this scenario, the front-stage totem-pole bridgeless rectifier operates in Boost Mode. In another operating scenario, the peak voltage of Vrec1 may be regulated to be the same as the peak voltage of Vac (assuming ideal components). In this scenario, the front-stage totem-pole bridgeless rectifier operates in Active Bridge Mode.

Boost Mode: The instantaneous AC input voltage Vac is:

$${V}_{a c} ( θ ) = \sqrt{2} {V}_{ac \_ rms} sin θ$$

The instantaneous voltage of Vrec1 is in phase with the input voltage Vac, which is:

$${V}_{r e c 1} ( θ ) = \sqrt{2} {V}_{rec 1\_ rms} sin θ$$

where Vac_rms and Vrec1_rms are the RMS value of Vac and Vrec1, respectively. θ is the phase angle and ranges from 0° to 180°. The instantaneous voltage gain G_{boost} of the front-stage totem-pole bridgeless rectifier is:

$${G}_{boost} ( θ ) = {V}_{bus} ( θ ) / {V}_{a c} ( θ ) = {V}_{rec 1\_ rms} / {V}_{ac \_ rms}$$

It can be observed that G_{boost} is a constant when θ changes from 0° to 180°. Hence, during steady-state operation, the duty cycle of the main switch is fixed at:

$${D}_{main} = ( {G}_{boost} - 1 ) / {G}_{boost}$$

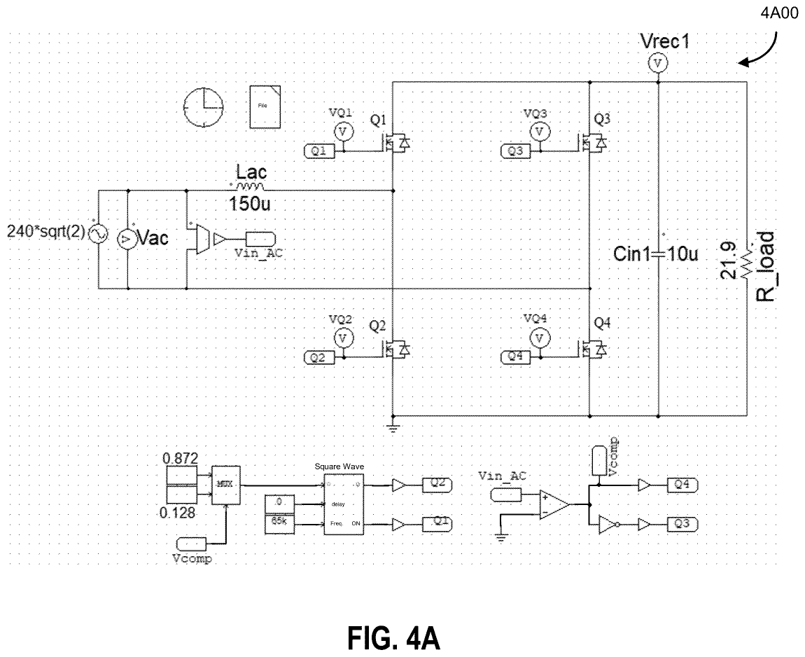

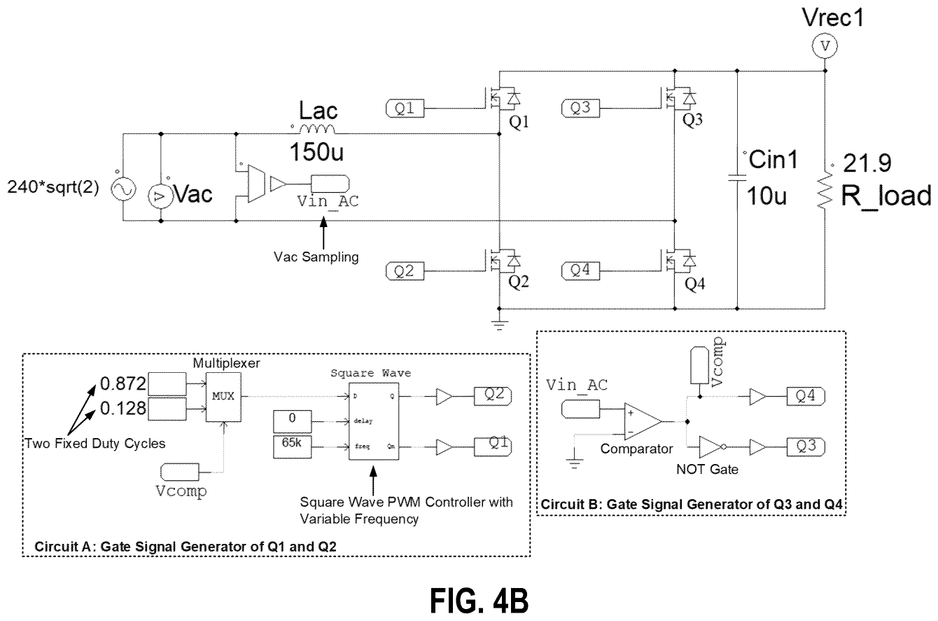

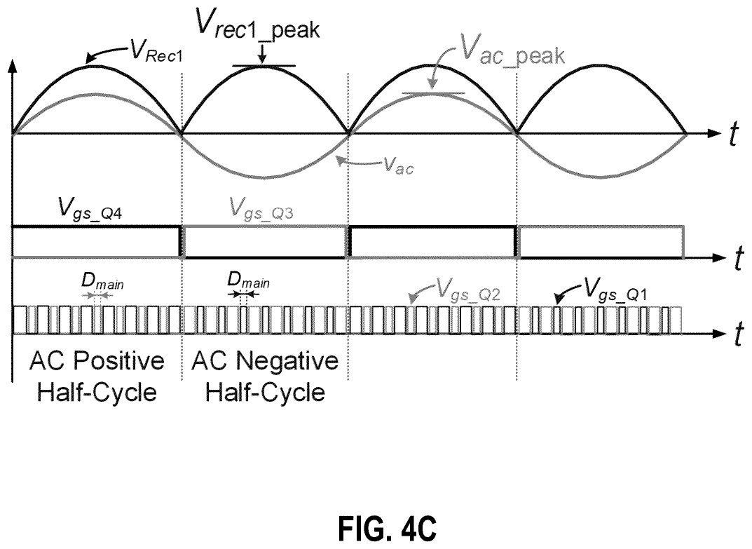

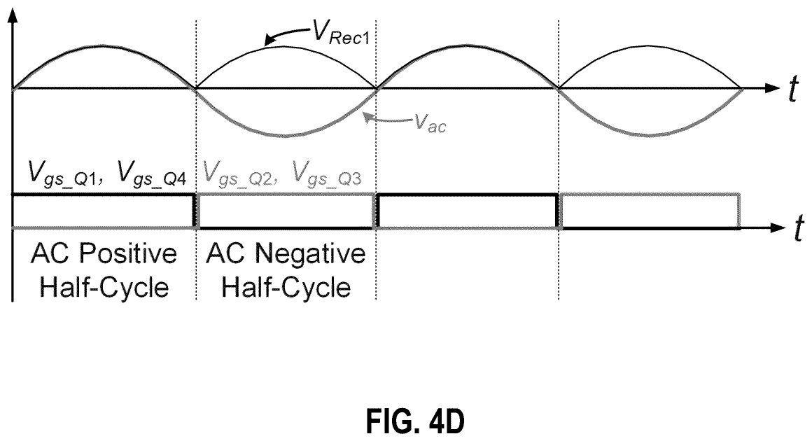

In FIG. 2B, MOSFETs Q1 and Q2 constitute the high-frequency (such as from 20 kHz to 500 kHz) switching leg, while MOSFETs Q3 and Q4 form the line-frequency switching leg. FIG. 4C illustrates the key waveforms during the Boost Mode operation of the front-stage totem-pole bridgeless rectifier. As depicted in FIG. 4A, when Vac is in the positive half-cycle, MOSFET Q2 serves as the main switch, and duty cycle Dmain is applied to MOSFET Q2. Conversely, when Vac is in the negative half-cycle, MOSFET Q1 serves as the main switch, and Dmain is applied to MOSFET Q1. Q3 and Q4, functioning as the line-frequency switching leg, alternate conduction at the line frequency. During the positive half-cycle of Vac, Q4 is turned ON while Q3 is turned OFF. Conversely, during the negative half-cycle of Vac, Q3 is turned ON while Q4 is turned OFF.

It is noted that the duty cycle value, Dmain remains same over one line cycle. As observed in FIG. 4C, Vrec1 is a half sinusoidal waveform and its peak value, Vrec1_peak, as shown in FIG. 4C, is higher than the peak value of the AC input, Vac_peak. For better performance, (higher efficiency and smaller size), it is desirable to set Vrec1_peak to be slightly higher than Vac_peak, such as Vrec1_peak is 5% higher than Vac_peak, Vrec1_peak=1.05×Vac_peak. In this case, Gboost=1.05, Dmain can be calculated as approximately 0.05, or 5%. With this operation condition, the voltage across the inductor, Lac, of the totem-pole bridgeless converter, such as shown in FIG. 2B, is small and its loss is also smaller. In a practical design, Vrec1_peak can be controlled to be 2% to 20% higher than Vac_peak.

To achieve PFC operation, the input current is required to be sinusoidal in phase with the input voltage, so the instantaneous input power Pac is:

$${P}_{a c} ( θ ) = \sqrt{2} {V}_{ac \_ rms} sin θ \cdot \sqrt{2} {I}_{in \_ rms} sin θ = 2 {P}_{i n} {sin}^{2} θ$$

where Iin_rms is the RMS value of the AC input current. Pin is the average input power. Assuming the efficiency of the totem-pole bridgeless rectifier is 100%, its instantaneous output power equals its instantaneous input power. Due to the very small value of C1, typically a few microfarads, the back-stage LLC converter is responsible for fully absorbing the instantaneous input power Pac to achieve the PFC functionality. In other words, Phase 1 achieves the PFC functionality by controlling the input current of the back-stage LLC converter to be a half-wave sinusoidal current, in phase with Vrec1.

Since the relationship between AC input current, lac, and the input current of the LLC converter, Irec1, can be expressed as:

$${I}_{a c} ( θ ) = {I}_{r e c 1} ( θ ) * {V}_{rec 1\_ peak} / {V}_{ac \_ peak}$$

In the above equation, theta (θ) is from 0 to 180 degrees. When theta (θ) is between 180 and 360 degrees, the following equation describes the relationship between Iac and Irec1

$${I}_{a c} ( θ ) = - {I}_{r e c 1} ( θ ) * {V}_{rec 1\_ peak} / {V}_{ac \_ peak}$$

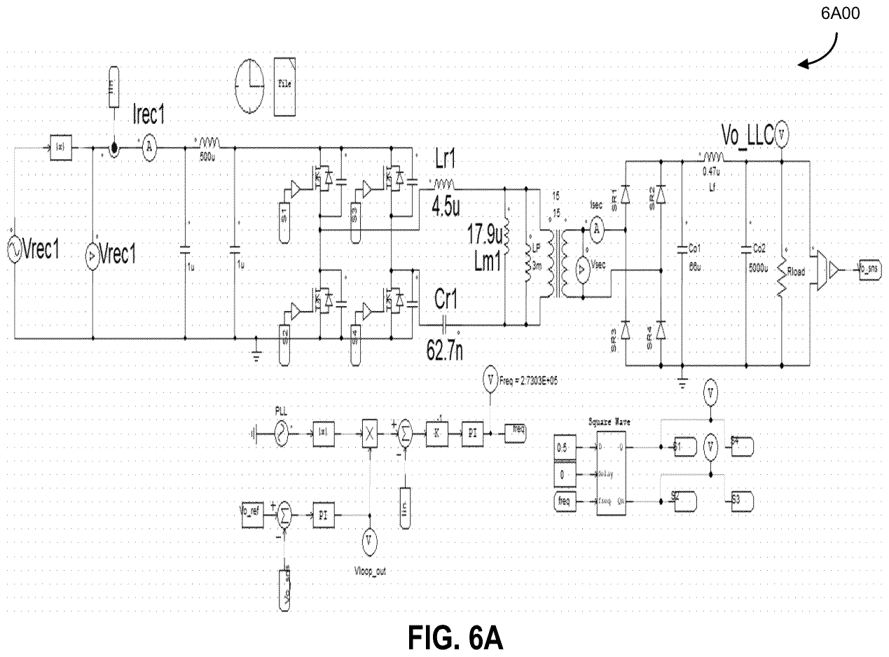

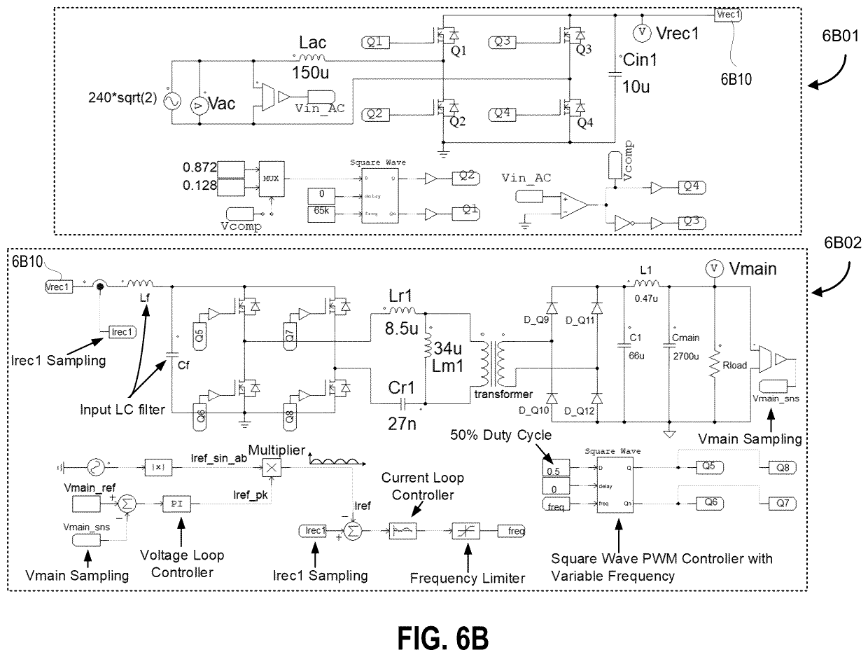

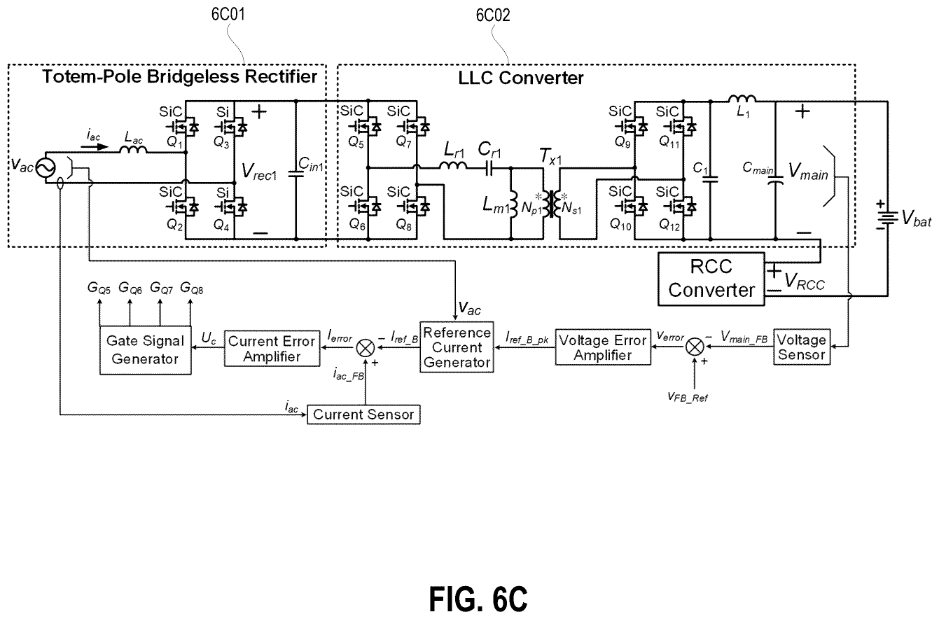

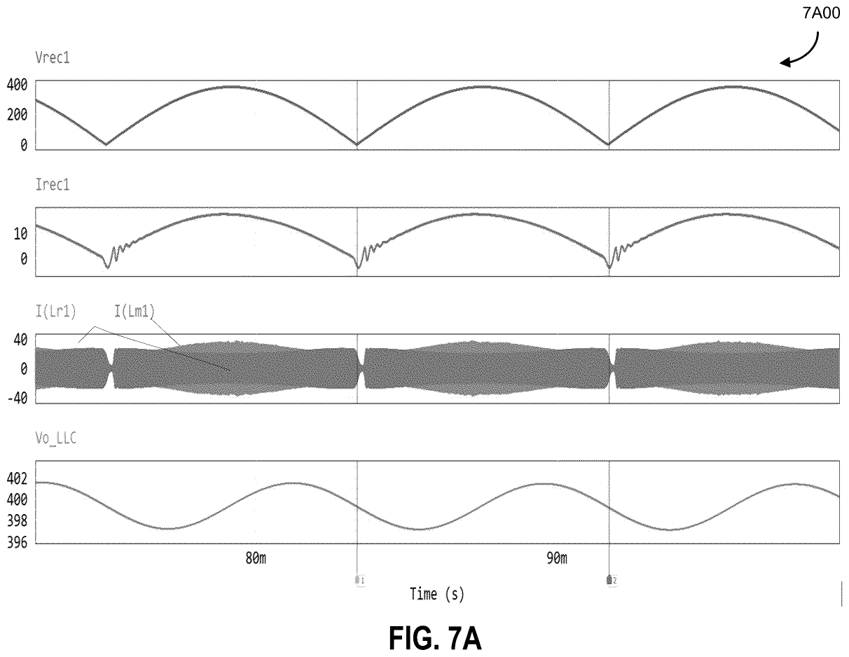

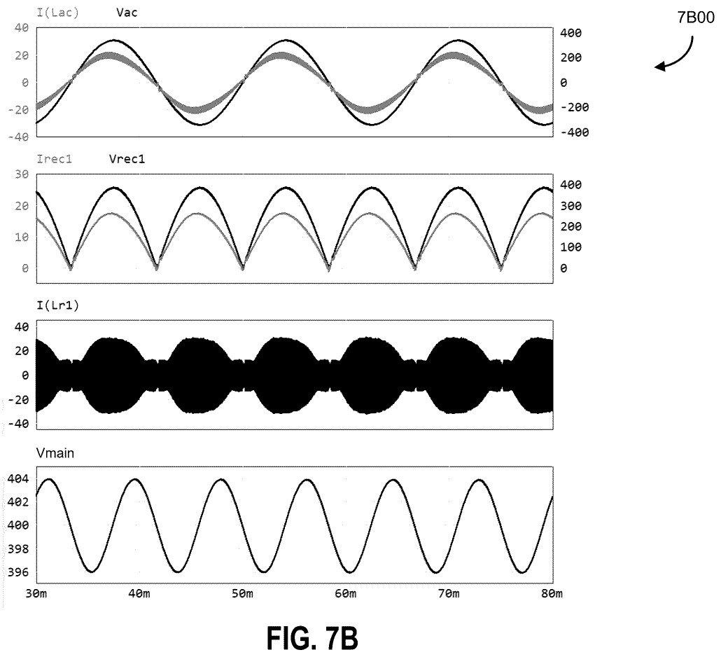

Therefore, one control strategy to achieve power factor correction is to control the input current of the back-stage LLC DC to DC converter, Irec1, as shown in FIG. 6B, to be a half sinusoidal waveform, as shown in FIG. 7B. With this control strategy, the current, Irec1, is sensed and compared with the reference current, Iref, as shown in FIG. 6B. The current loop controller will generate the required switching frequency signal so that Irec1 is a rectified sinusoidal waveform. It is noted that Iref comes from the output of the voltage error amplifier, as shown in FIG. 6B. More specifically, the voltage loop controller produces the peak value of the reference current, Iref_pk, which is multiplied by a sinusoidal function, Iref_sin_ab, to generate the rectified sinusoidal waveform, Iref, as shown in FIG. 6B.

Another control strategy to achieve power factor correction is to directly control the AC input current into sinusoidal, as shown in FIG. 6C. With this control strategy, the input AC current (lac) is sensed and compared with the reference current, Iref_B, as shown in FIG. 6C. The Current Loop Controller and Gate Signal Generator will generate the required switching frequency signals to Q1, Q2, Q3, Q4, so that Iac is a sinusoidal waveform. It is noted that Iref_B comes from the output of the voltage error amplifier, as shown in FIG. 6C. More specifically, the Voltage Error Amplifier produces the peak value of the reference current, Iref_B_pk. The actual input current reference, Iref_B is generated by multiplying the Vac (or a rectified sinusoidal function) and Iref_B_pk, as indicated by Reference Current Generator, as shown in FIG. 7C.

An important advantage of the proposed first AC-DC power stage (front-stage) is that a small value of a capacitor, Cin1, is possible due to the specific operation of the topology. Cin1 is used to filter out the switching frequency ripple and the voltage across Cin1 is a rectified sinusoidal waveform. The small value of Cin1, for example, in the order of 10 microfarads, allows for more flexibility in component selection and power ratings.

In alternate conventional circuits, the value of Cin1 is large, the voltage across Cin1 is basically a DC voltage, and the front stage (AC to DC power stage) processes all the power from input to output. In contrast, in the proposed circuit, Cin1 is small and the duty cycle (Dmain) is constant and small, and thus less power is being used and there is higher efficiency (especially from the perspective of full load efficiency). Applicants estimate that the first stage from Vac to Vrec1 is more than 99%-99.5% efficiency at full load, while approaches using a large Cin, are at approximate 98% efficiency at full load, and thus the proposed circuit can potentially reduce losses by half, which not only saves power but also reduces heat losses.

FIG. 4B is an illustration 400 that provides the PSIM simulation model of the totem-pole bridgeless rectifier which operates in Boost Mode. In this model, Lac is 150 μH, Cin1 is 10 μF, and the load resistor R_load is 21.9 ohms. The switching frequency is set at 65 kHz. The simulation conditions include a 240 Vac input and a 3.3 kW output.

The control circuit consists of two parts, namely Circuit A and Circuit B. Circuit A functions as the gate signal generator for Q1 and Q2, while Circuit B serves the gate signal generator for Q3 and Q4. In Circuit B, Vin_AC represents the sampled value of the input AC voltage Vac. After passing through a comparator, it outputs a control signal Vcomp. A value of 1 for Vcomp indicates the positive half-cycle of the Vac sinusoidal voltage, while a value of 0 indicates the negative half-cycle. When Vcomp is 1, the gate signal for MOSFET Q4 is set high, and the gate signal for MOSFET Q3 is set low. Conversely, when Vcomp is 0, the gate signal for MOSFET Q4 is set low, and the gate signal for MOSFET Q3 is set high.

In Circuit A, Vcomp is fed into a multiplexer to select the duty cycle of the switch. During the positive half-cycle of the input voltage Vac, where Vcomp is 1, a duty cycle of Dmain=0.128 applies to the main switch Q2, while switch Q1 operates complementarily as the synchronous rectifier with duty cycle of 1-0.128=0.872. During the negative half-cycle of the input voltage Vac, where Vcomp is 0, the duty cycle of Dmain=0.128 applies to the main switch Q1, and switch Q2 operates complementarily as the synchronous rectifier with duty cycle of 1−0.128=0.872. A function block from PSIM, “square wave PWM controller with variable frequency”, is used to generate gate signals for Q1 and Q2. The switching frequency is fixed at 65 kHz.

It is noted that under the above control, the AC current is sinusoidal so that the power factor correction is achieved. In real implementation, feedback control will be used so that the current through the Boost inductor current is pure sinusoidal. Since the output capacitor of the totem-pole bridgeless rectifier is very small, 10 uF used in the simulation, the output voltage, Vrec1 as shown in FIG. 2B, or Vrec1 as shown in FIG. 4B, will be changing from a very low voltage level (close to 0V) to a peak voltage of around 380V (a little bit higher than the peak value of the AC voltage). The waveform of Vrec1 is shown in FIG. 4C. No electrolytic capacitor is used at the output of the totem-pole bridgeless rectifier, as shown in FIG. 4B. In practical circuit implementation, feedback control may be employed to regulate the peak voltage of Vrec1 (Vrec1_pk) in a closed-loop manner. In other words, the peak voltage of Vrec1 (Vrec1_peak) is controlled to a constant value under varying input AC voltages.

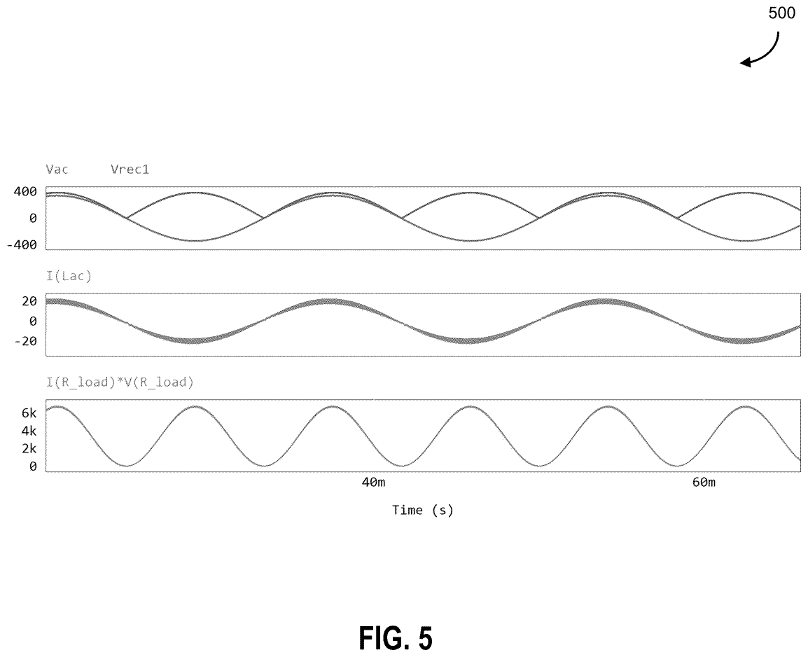

One significant benefit of the proposed power architecture, as shown in FIG. 2B, is that the output voltage of the totem-pole bridgeless rectifier can be regulated to be slightly higher than the input voltage, as shown in FIG. 5. In FIG. 5, a diagram 500 is provided, where Vrec1 is the output voltage of the totem-pole bridgeless rectifier and Vac is the input AC voltage. Therefore, the switching loss for Q1 and Q2 (FIG. 2B) is very small because the switching loss depends on the voltage across the switches. The switching loss is much smaller than the conventional Boost converter where the output voltage is always at a high level (such as 400V). Additionally, the high-frequency ripple current on the inductor Lac can be significantly reduced due to the decreased voltage boost ratio. This implies that the value of Lac can be smaller than that of the conventional Boost converter where the output capacitor with large output capacitor is used. The proposed technology can reduce the volume and losses of Lac, thus enhancing the overall efficiency and power density of the system.

This is significantly different from the regular Totem-Pole Bridgeless Boost converter operation. With a regular Totem-Pole Boost converter, the output voltage is almost a DC voltage (such as 400V which is higher than the peak value of the AC voltage) with a small double line frequency (100 Hz, or 120 Hz) ripple voltage (such as +/−10V).

FIG. 5 gives the simulation waveforms of Vac, Vrec1, Lac inductor current I(Lac), and the Instantaneous output power which is represented by I(R_load)*V(R_load). It can be observed that the output voltage Vrec1 is a half-wave sinusoidal waveform with a fixed peak voltage of 380 V. The rms value of the input AC voltage is 240V. The PFC functionality is well-maintained, as the AC input current, which is the same as the current through inductor, Lac, I(Lac) remains in phase with Vac. This indicates that the back-stage LLC converter can be controlled and behave as a pure resistor to achieve the PFC functionality.

Active Bridge Mode: When the totem-pole bridgeless rectifier operates in Active Bridge Mode, MOSFETs Q1-Q4 all operate at line frequency. As depicted in FIG. 4D, during the positive half-cycle of Vac, the gate signals for MOSFETs Q1 and Q4 are set high, while those for MOSFETs Q2 and Q3 are set low. Conversely, during the negative half-cycle of Vac, the gate signals for MOSFETs Q2 and Q3 are set high, while those for MOSFETs Q1 and Q4 are set low. In this configuration, MOSFETs Q1-Q4 form an active bridge. The peak voltage of Vrec1 will be the same as the peak voltage of Vac (assuming ideal components). As depicted in FIG. 4D, during the positive half-cycle of Vac, the waveform of Vrec1 is identical to that of Vac. During the negative half-cycle of Vac, the waveform of Vrec1 is opposite to that of Vac.

Under Active Bridge Mode, the totem-pole bridgeless rectifier experiences minimal losses. This is because MOSFETs Q1-Q4 do not require high-frequency switching, thus avoiding additional switching losses and driving losses. Additionally, there is no high-frequency ripple current on Lac, significantly reducing both core losses and winding losses.

It is worth noting that when the totem-pole bridgeless rectifier operates in Active Bridge Mode, the back-stage LLC converter also needs to be controlled to behave as a pure resistor to achieve the PFC functionality.

FIG. 6B depicts the complete PSIM simulation model of the forward operation of the isolated AC-DC stage shown in FIG. 2B. The simulation model in FIG. 6B can be divided into two sections. The upper section (6B01) represents the totem-pole bridgeless rectifier operating in Boost Mode. This portion of the simulation circuit is identical to the one presented in FIG. 4B, except that the load resistor R_load in FIG. 4B is replaced by the LLC converter. Therefore, no additional introduction will be provided for this part of the circuit.

The lower section of FIG. 6B illustrates the LLC converter and its control circuit. Please note that in the simulation model, voltage Vrec1 is connected together between upper box and lower section through symbol Vrec1, 6B10. The power train circuit includes an LC input filter, a full-bridge inverting network (Q5 to Q8), a resonant tank, a full-bridge rectifying network, and a CLC output filter. The LC filter at the input of the LLC converter (Lf and Cf) is utilized to attenuate the ripple current induced by the high-frequency switching of the LLC converter. The resonant tank includes Lr1 (8.5 uH), Cr1 (27 nF), and Lm1 (34 uH), with the transformer turns ratio set at 1:1. The full-bridge rectifying network consists of D_Q9, D_Q10, D_Q11, and D_Q12, representing the body diodes of Q9, Q10, Q11, and Q12 as depicted in FIG. 2B. The CLC output filter (C1, L1, and Cmain) is employed to filter out the switching-frequency ripple current from the full-bridge rectifying network. Typically, C1 is chosen as a ceramic or film capacitor with low parasitic resistance, while L1 is selected as a compact, low-cost surface-mount or I-shape leaded power inductor with values ranging from hundreds of nanohenries to several microhenries. With L1, C1, the switching frequency ripple flows through C1 and the double line frequency ripple flows through Cmain. Cmain, which is typically an electrolytic capacitor with a larger capacitance (e.g., several thousand microfarads), determines the magnitude of the double-line frequency ripple on the output voltage Vmain of the LLC converter. A larger Cmain results in smaller double-line frequency ripple on Vmain, and vice versa. In this simulation model, Cmain is set to 2700 uF. The output conditions are selected as 400 V/3.3 KW. As mentioned earlier, to achieve the Power Factor Correction (PFC) functionality, the LLC converter needs to be controlled to behave as a pure resistor. To achieve this control objective, a typical dual-loop control architecture can be employed (i.e., input current Irec1 is in phase with Vrec1).

As depicted in the lower section of FIG. 6B, the LLC controller circuit utilizes a dual closed-loop control system comprising an outer voltage loop for stabilizing the LLC output voltage (Vmain) and an inner current loop to ensure that the input current (Irec1) is in phase with Vrec1. Initially, the output voltage of the LLC converter, Vmain, is sampled and compared with a predetermined reference voltage, Vmain_ref, to generate a voltage error signal. This voltage error signal is then fed into the voltage loop controller, where a PI controller is employed in the simulation. To generate the full-wave rectified sinusoidal reference current for the current loop, denoted as Iref, a multiplier is utilized. This process involves multiplying the voltage controller output, Iref_pk, by the value of Iref_sin_ab, which represents a normalized full-wave rectified sinusoidal waveform. It is worth noting that in practical circuit implementation, zero-crossing information of Vac is needed to determine the phase of Iref_sin_ab.

In the inner current loop, real-time sampling of the LLC converter input current, Irec1, is essential. This can be achieved by sampling the current in Lf. Once sampled, Irec1 is compared with Iref to generate a current error signal. This signal is then fed into the current loop controller, which utilizes a type-3 controller in the simulation. After passing through a frequency limiter, the output of the current loop controller is converted into a frequency control signal, determining the switching frequency of MOSFETs Q5-Q8. A block named “Square Wave PWM Controller with Variable Frequency” is utilized to process the frequency information generated by the dual-loop controller and generate 50% duty cycle gate signals for MOSFETs Q5-Q8.

This dual loop control architecture is effective at addressing the technical challenge associated with controlling the LLC converter to behave as a pure resistor.

FIG. 7B presents simulation waveforms, encompassing I(Lac), Vac, Irec1, Vrec1, I(Lr1), and Vmain. The LLC resonant current I(Lr1) displays low frequency envelope while the switching frequency waveforms are not shown clearly. The output voltage Vmain remains stable at around 400 V with a peak-to-peak voltage ripple of approximately 8 V. Notably, Irec1 is in phase with Vrec1, indicating that the back-stage LLC converter can be effectively controlled to operate as a pure resistor. In this case, the Power Factor Correction (PFC) functionality of this isolated AC-DC stage can be maintained. As illustrated by the waveforms of I(Lac) and Vac in FIG. 7B, I(Lac) is sinusoidal and in phase with Vac, with the measured power factor reaching as high as 0.99. Based on the discussion above, here are some key points summarizing the operation of Phase 1 (as shown in FIG. 2A), the circuit shown in FIG. 2B, during forward operation:

(1) The operation of the totem-pole bridgeless rectifier involves two modes: Boost Mode and Active Bridge Mode. When the totem-pole bridgeless rectifier operates in Active Bridge Mode, it experiences minimal losses. Under Active Bridge Mode control, the peak voltage of Vrec1 depends on the input AC voltage Vac. For instance, assuming the rms value of Vac ranges from 216 Vac to 264 Vac, then the peak voltage of Vrec1 varies between 305V (216*1.414=305) and 373V (264*1.414=373). This voltage range increases the demand for peak gain in the back-stage LLC converter, increasing the design complexity and conversion loss of the LLC converter. Therefore, when losses in the totem-pole bridgeless rectifier in Phase 1 (see FIG. 2A) dominate, utilizing the Active Bridge Mode control method is appropriate.

(2) When the totem-pole bridgeless rectifier operates in Boost Mode, the input voltage of the LLC converter, Vrec1 (i.e., the output voltage of the totem-pole bridgeless rectifier), can be controlled either in an open-loop manner using a fixed duty cycle or in a closed-loop manner employing a variable duty cycle. In scenarios where losses in LLC converters dominate, implementing closed-loop control for the totem-pole bridgeless rectifier is advisable. In such instances, Vrec1 can be regulated to be a full-wave rectified sinusoidal voltage with a fixed peak voltage (e.g., a full-wave rectified sinusoidal voltage with a peak of Vrec1_peak=380 V) while the input AC voltage varies. This approach significantly reduces the LLC converter's peak gain requirements, thereby increasing its energy conversion efficiency. Compared to the totem pole bridgeless rectifier based on the Active Bridge Mode, assuming that Vac ranges from 216 Vac to 264 Vac (i.e., Vrec1_peak varies between 305V and 373V), the LLC converter's peak gain requirement can be reduced by 18.2% (calculated by (373−305)/373).

The input current of the LLC converter is controlled such that the LLC converter will behave like a resistor. When the instantaneous value of Vrec1 is high, the instantaneous input current of the LLC converter is higher. When the instantaneous value of Vrec1 is lower, the instantaneous input current of the LLC converter is lower also. This can be achieved by the feedback control.

### 2) Forward Operation of Phase 2:

In the forward operation, the operation principle and design approach of Phase 2 (as shown in FIG. 2A) are consistent with those of a conventional LLC PFC converter, as detailed in “A mathematical guideline for designing an AC-DC LLC converter with PFC” 2018 IEEE Applied Power Electronics Conference and Exposition (APEC), which is hereinafter incorporated by reference.

### 3) Forward Operation of RCC Converter:

For battery voltages ranging from 240 V to 450 V, the maximum average value of Vₘₐᵢₙ can be limited to 400V. In this scenario, a 450V-rated electrolytic capacitor can be utilized for Vₘₐᵢₙ and provide enough margin, reducing costs and extending the capacitor's operational lifespan. When Vbat is less than or equal to 400V, the entire charging power is supplied by Vₘₐᵢₙ. In other words, the average value of Vₘₐᵢₙ, V_{main_avg}, equals V_{bat} when V_{bat} is less than or equal to 400V. Under this condition, V_{RCC} is used to eliminate the double-line frequency ripples on Vₘₐᵢₙ and does not provide active power output. For example, when the battery voltage is at 380V, the Vmain_avg is regulated at 380V and the RCC is to eliminate the double line frequency ripple contained in Vmain. The average value of V_{RCC} is zero. When the battery voltage is 400V, Vmain_avg is regulated at 400V and the RCC converter is to eliminate the double line frequency contained in Vmain. So that the combined voltage (Vmain+VRCC) contains only DC voltage, which will be applied to the battery terminal.

When the voltage of V_{bat} exceeds 400V, Vmain_avg remains at 400V. The portion of V_{bat} voltage exceeding 400V is compensated by V_{RCC}_avg (average value of voltage V_{RCC}). In this situation, V_{RCC} serves the dual purpose of eliminating double-line frequency ripples on Vₘₐᵢₙ and providing active power output. For example, when the battery voltage is at 420V, Vmain_avg is still regulated at 400V. The RCC converter will produce a DC average voltage with value of VRCC_avg=20V plus a double line frequency ripple with same magnitude and opposite phase to eliminate the double line frequency contained in Vmain so that the combined voltage (Vmain+VRCC) contains only DC voltage, which will be applied to the battery terminal.

Please note that the above discussion uses a specific set of numerical values, such as 380V, 400V, 420V, 450V, as an example to illustrate an optimal strategy to select the voltage rating of Cmain. The objective is to select the Vmain slightly lower than the voltage rating of Cmain so as to fully utilize the capacitor, Cmain. The phase “slightly lower” means to provide enough margin between voltage stress and voltage rating of the capacitor, Cmain. In the above example, the maximum battery voltage is 450V. If the maximum average value of Vmain is set at 400V and considered 10V ripple, the maximum voltage stress of Cmain is 410V. This will leave 40V margin for the Cmain voltage rating, which is considered reasonable. In order to generate 450V to charge the battery, the average output voltage of the RCC converter, VRCC_avg is 50V and the ripple voltage is 10V peak. In other words, the RCC converter will produce a voltage varying between 40 and 60V to boost 50V DC to Vmain and to cancel the ripple voltage of Vmain.

The same strategy to select the voltage rating of Cmain can also be used for other battery voltage levels. The key idea is to select the voltage stress of Cmain to be close to and slightly lower than its voltage rating to maximize the utilization of the capacitor, Cmain.

FIG. 3B is a block diagram illustrating a control architecture used to control the forward operation of the RCC converter shown in FIG. 3A, where the battery is in a constant current charging state. In the power circuit of FIG. 3B, there are three independent controlled variables: Vmain, Ibat, and Vlink.

Vmain is the output voltage of the single stage isolated AC-DC stage and is controlled by the isolated AC-DC stage controller shown in FIG. 3B. Due to the power factor correction nature of the isolated stage, Vmain contains a voltage ripple at the double line frequency (120 Hz in North America and 100 Hz in Europe and China). The isolated AC-DC stage controller has been discussed in detail in previous analysis, such as shown in FIG. 7B, and will not be elaborated on here. The focus here is on the forward operation of the RCC converter.

In FIG. 3B, the RCC inverter controller circuit (3B01) aims to regulate the battery output current to a predetermined constant DC value, Ibat_Ref. The battery current, ibat, is sensed by a current sensor. The output of the current sensor is a real-time sample of the battery current, ibat_FB. Ierror represents the current error signal, obtained by subtracting ibat_FB from Ibat_Ref. Ibat_Ref is a predetermined reference current value that reflects the current charging requirement of the battery. Through a current loop controller, Ierror is converted into Uc1, which serves as the control signal for the gate signal generator. This gate signal generator converts the Uc1 signal into the gate driving signals for the MOSFETs Q19-Q22 in the RCC inverter (3B04), adjusting the output voltage V_{RCC} accordingly. Consequently, V_{RCC} is controlled to have the same magnitude as the ripple voltage of Vmain but in reverse phase, ensuring that Vmain+V_{RCC} is ripple-free, allowing the required DC current, ibat, to flow through the battery.

In an EV battery charger application, the Vmain is normally between 250V to 450V or between 500V to 900V. The ripple voltage of Vmain is between 2.5V to 20V peak value for a practical design. Therefore, the RCC LLC converter (3B03) in FIG. 3B is used to convert the Vmain to a lower voltage value, Vlink, which is about 1.5 to 2 times the peak value of V_{RCC} (VRCC_peak), or the peak value of Vmain ripple.

$$Vlink = K * VRCC\_peak , where K > 1 , K = 1.5 to 2 can be selected .$$

For example, if the peak ripple voltage is 10V, Vlink can be selected between 15 and 20V.

When VRCC contains a DC value and a ripple value, the Vlink should be higher than the maximum value of VRCC, VRCC_max=VRCC_avg+V_RCC_ripple.

It is noted that a half bridge LLC converter is used as the RCC LLC converter (3B03) in FIG. 3B. It is noted that other topologies, such as full-bridge LLC, DAB (Dual Active Bridge) converter, etc., can also be used as 3B03.

Capacitor C3 serves as an intermediate energy storage component between the RCC LLC converter (3B03) and the RCC inverter (3B04). The voltage across C3 is Vlink, which is both the input voltage to the RCC inverter (3B04) and the output voltage of the RCC LLC converter (3B03). In FIG. 3B, the RCC LLC controller circuit (3B02) is responsible for regulating Vlink based on its reference value, Vlink_Ref. Therefore, a voltage loop can be used to control Vlink. In the RCC LLC Controller Circuit (3B02), Vlink_FB is the output of a voltage sensor that provides a real-time sample of Vlink. Verror represents the voltage error signal, calculated by subtracting Vlink_FB from Vlink_Ref. This error signal, Verror, is processed by a voltage loop controller and converted into Uc2, which serves as the control signal for the gate signal generator. This gate signal generator converts the Uc2 signal into the gate driving signals for the MOSFETs Q17 and Q18 in the RCC LLC converter (3B03).

To ensure the proper operation of the RCC inverter (3B04), the value of Vlink must be higher than the peak voltage of the sinusoidal VRCC. This means that in the RCC LLC controller circuit (3B02), the value of Vlink_Ref must be set based on the output voltage VRCC of the RCC converter (3B03).

The Vlink reference generation block in the RCC LLC controller circuit (3B02) calculates VRCC by sampling Vbat and Vmain, because according to Kirchhoff's Voltage Law (KVL), VRCC=Vbat−Vmain. Therefore, Vlink_Ref can be determined accordingly. In other words, Vlink_Ref can be set to be higher than the peak voltage of the sinusoidal VRCC by the Vlink reference generation block. This can optimize the operation of the RCC Inverter (3B04). For example, if VRCC produces a zero DC value and 10V peak ripple voltage, Vlink_Ref can be set at 15V. If VRCC produces a 20V DC value and 10V peak ripple value (with VRCC maximum value of 30V), Vlink_Ref can be set at 40V (10V higher than the maximum VRCC value).

### Backward Operation

In backward operation, power is delivered from the DC battery to the AC side. The output of the RCC converter will be short-circuited. As depicted in FIG. 3A, this short-circuiting of the RCC converter can be achieved by setting the driving signals of MOSFETs Q19, Q20, Q20, and Q21 to a constant high level, while simultaneously setting the driving signals of Q17 and Q18 to a constant low level. Thus, Q19, Q20, Q21, Q22 are turned on and Q17, Q18 are turned off. Consequently, Vbat is directly applied to Phase 1 in FIG. 2A, or the circuit as shown in FIG. 2B, which functions as a DC to AC inverter. It is noted that in FIG. 2A, Phase 2 is not designed for backward operation because of the diode bridges (D5 to D8 and D1 to D4).

When the bidirectional AC-DC rectifier operates in off-grid backward mode, the AC side should produce a sinusoidal AC voltage. When the bidirectional AC-DC rectifier operates in grid-connected backward mode, the AC side should produce an AC current that tracks the grid sinusoidal voltage at all times. The following discussion mainly focuses on the control strategies for the bidirectional AC-DC rectifier operating in off-grid backward mode. The description is basically the same for grid connected operation.

It is noted that in backward operation, the LLC converter produces the Vrec1. Three control methods are proposed, differing mainly in the waveform of Vrec1.

The first method entails controlling Vrec1 to be a full-wave rectified sinusoidal voltage with the lowest voltage close to or equal to 0. This is termed Backward Mode A.

The second method involves regulating Vrec1 to be a full-wave rectified sinusoidal voltage with the lowest voltage limited to Vrec1_min. This is termed Backward Mode B.

The third method aims to maintain Vrec1 as a constant DC voltage without any double-line frequency voltage ripple. This is termed Backward Mode C.

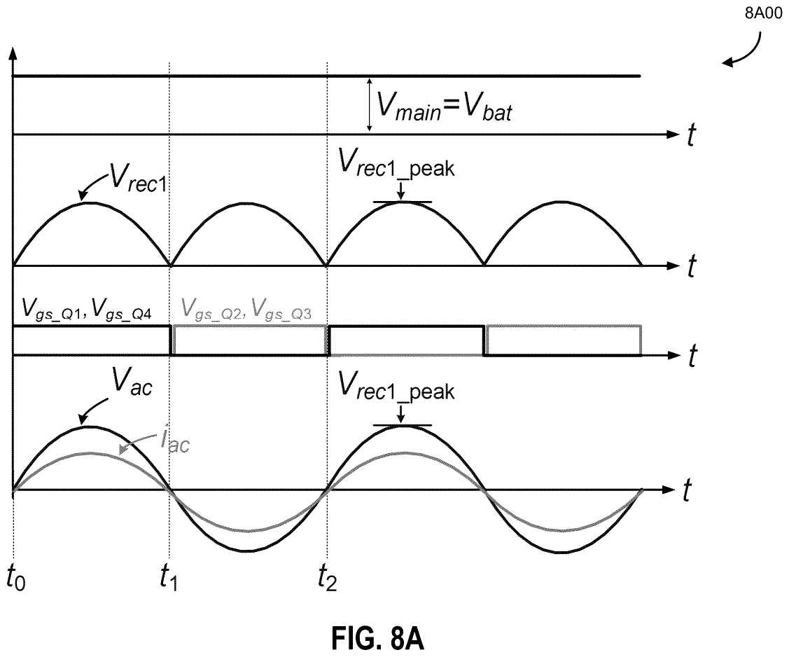

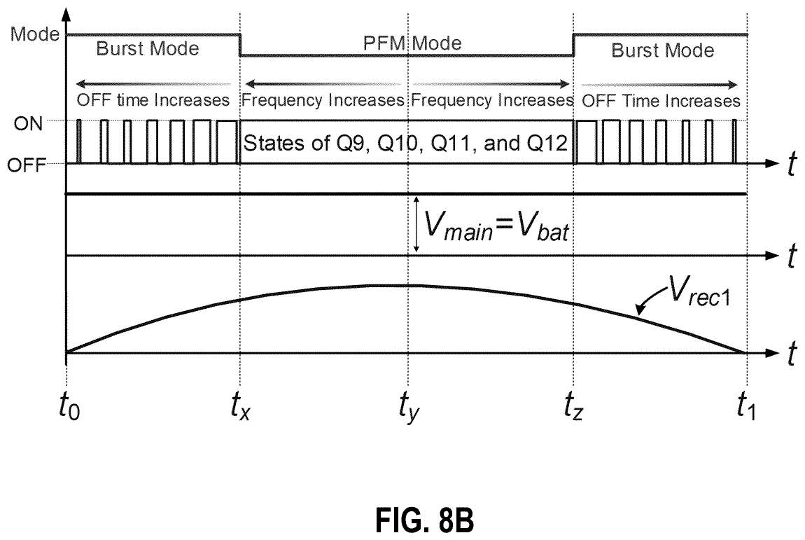

Backward Mode A: In Backward Mode A, the LLC converter converts the battery voltage V_{bat} into a full-wave rectified sinusoidal voltage with a peak value of V_{rec1_peak}, as illustrated in FIG. 8A. In FIG. 2A, Q1, Q2, Q3, Q4, Lac, form a low frequency (50 or 60 Hz) full-bridge inverter circuit that converts the half-wave sinusoidal V_{rec1} into a sinusoidal waveform Vac. As depicted in FIG. 8B, during the period from t0 to t1, the gate driving signals of Q1 and Q4 (as shown in FIG. 2A) are set to a constant high level, and the gate driving signal of Q2 and Q3 are set to low. So Q1, Q4 are on and Q2, Q3 are off. Therefore, the waveform of Vac is identical to that of Vrec1.

During the period from t1 to t2, the gate driving signals of Q2 and Q3 in Phase 1 are set to a constant high level, and the waveform of Vac is opposite to that of Vrec1. Cin1 and Lac do not exhibit double-line frequency ripple, and they solely contain the high-frequency switching ripple introduced during LLC backward operation (in the range of several hundred kHz). Consequently, the values of Cin1 and Lac can be selected to be very small.

There are several control methodologies that assist in shaping Vrec1 into a full-wave rectified sinusoidal voltage ranging from 0 to Vrec1_peak, as shown in FIG. 8B. Pulse Frequency Modulation (PFM) control can be employed when Vrec1 is near its peak voltage, such as from tx to tz. As the value of Vrec1 decreases, the LLC converter requires lower voltage gain. Hence, phase shift modulation or burst mode control can be employed. FIG. 8B illustrates key waveforms during half of a line cycle when the LLC converter operates in backward mode. The moment ty signifies when the output AC voltage Vac is at 90°. Within the time interval [tx, tz], the LLC converter operates in PFM Mode, and the switching frequency serves as the control variable. From ty to tx or from ty to tz, the switching frequency of the LLC converter increases, leading to a reduction in the voltage gain during LLC backward operation, thereby causing Vac to decrease. At times tx and tz, the LLC converter reaches the maximum allowed switching frequency.

Utilizing burst mode control (where the switching frequency remains constant), Vrec1's voltage can be further reduced during LLC backward operation without sacrificing system switching losses. Within the time intervals [t0, tx] and [tz, t1], the LLC converter operates in burst mode, and the OFF time of Q9-Q12 serves as the control variable. The driving signals for Q9-Q12 are periodically blocked, allowing Vrec1 to be regulated to a very low value. The longer the OFF time, the lower Vrec1's voltage can be controlled. When all driving signals are blocked, Vrec1's voltage theoretically approaches 0, corresponding to the voltage value of Vrec1 at time t0 and t1. It is noted that phase-shift control can also be used for time interval between t0 and tx and between tz and t1, as shown in FIG. 8B.

In Backward Mode A, the operation of the full-bridge inverter circuit (comprising Q1, Q2, Q3, Q4, Lac) incurs only conduction losses. Since Q1, Q2, Q3, Q4 do not require high-frequency switching, there are no additional switching losses, conduction losses, or core losses on Lac.

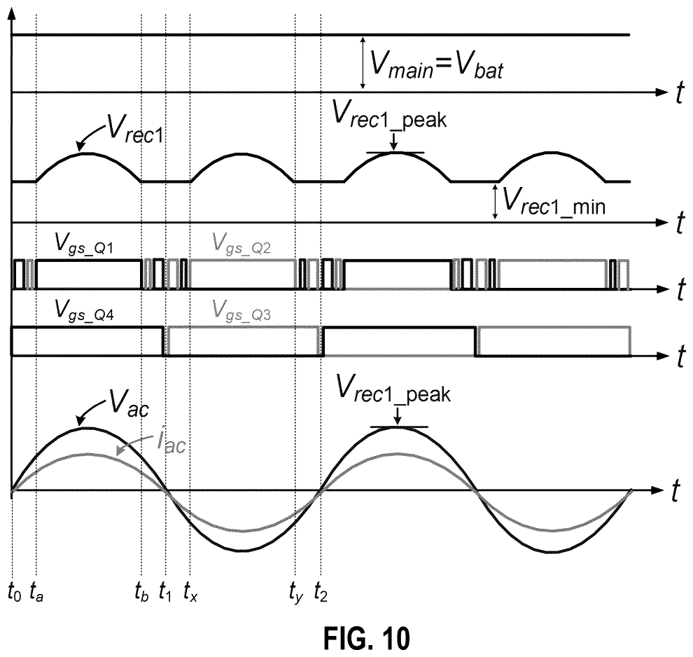

Backward Mode B: In Backward Mode B, the LLC converter regulates the battery voltage Vbat into a full-wave rectified sinusoidal voltage with the lowest voltage limited to Vrec1_min, as depicted in FIG. 10. In FIG. 10, the time duration from t0 to t2 represents a complete AC line cycle. The voltage waveform of Vrec1 is controlled to be sinusoidal during [ta, tb] and [tx, ty]. The output voltage Vrec1 remains constant at Vrec1_min during [t0, ta], [tb, tx], and [ty, t2]. Compared to Backward Mode A, the output voltage variation of the LLC converter is between Vrec1_min and Vrec1_peak, which is narrower than the output voltage variation of the LLC converter under mode A, described above. Hence, the burst mode operation in FIG. 8B may be eliminated. In other words, the LLC converter can achieve the control objective of the Vrec1 waveform in FIG. 10 solely through PFM. This significantly reduces the control complexity during LLC backward operation.

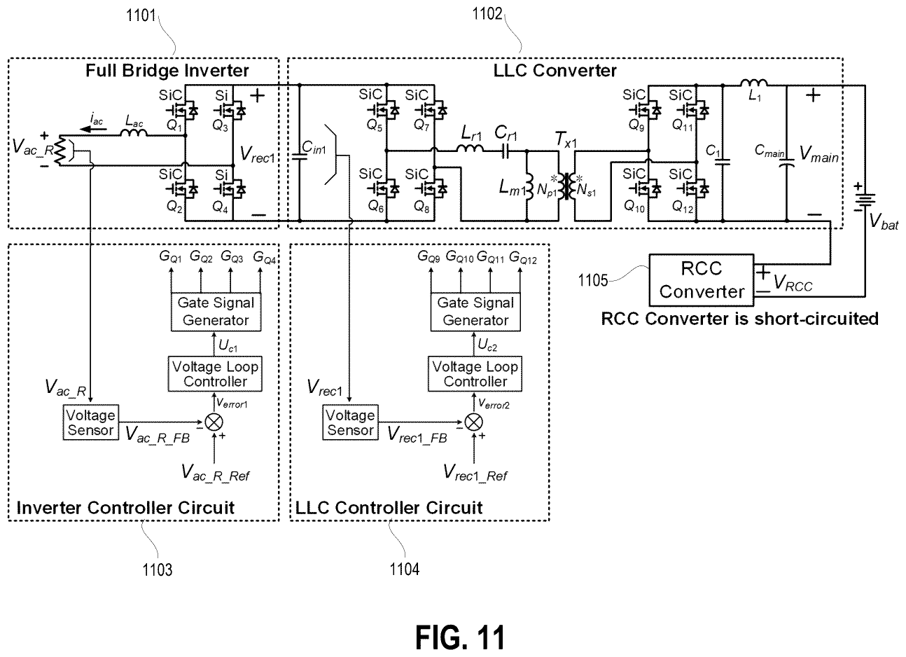

During [ta, tb], the driving signals of Q1 and Q4 as shown in FIG. 11 remain at a constant high level and Q1, Q4 are turned on resulting in Vac having an identical waveform to Vrec1. During [tx, ty], the driving signals of Q2 and Q3 remain at a constant high level and Q2, Q3 are turned on, causing Vac to exhibit a waveform opposite to that of Vrec1.

In other words, from time t=ta to t=tb and from t=tx to t=ty, the Full Bridge Inverter, as shown as box 1101, operates as Inversion Active Bridge Mode. It is noted that box 1101 is basically the same as the bi-directional AC to DC converter, as shown in FIG. 2B, as box 2B01, operating at inverter mode,

During [t0, ta], [tb, tx], and [ty, t1], Q1, Q2, Q3, Q4, Lac, in FIG. 2B constitute a high-frequency full-bridge inverter circuit, operating within the frequency range of tens to hundreds of kHz (such as from 20 kHz to 500 kHz). This inverter circuit modulates the DC voltage Vrec1_min into the sinusoidal waveform Vac corresponding to these time intervals. Various control methods such as unipolar, bipolar, or double-frequency unipolar can be employed in the high-frequency inverter circuit. FIG. 10 depicts the schematic waveforms of the driving signals for MOSFETs Q1-Q4 based on the unipolar control method. The switching strategy of MOSFETs Q1-Q4 from tb to tx is used to illustrate the implementation of the unipolar control method. During [tb, t1], MOSFET Q4 remains on. MOSFETs Q1 and Q2 perform high-frequency switching to step down Vrec1_min to sinusoidal positive Vac. MOSFET Q1 serves as the main switch, while MOSFET Q2 acts as the synchronous rectifier. Thus, the duty cycle generated by the control loop should apply to MOSFET Q1.

During [t1, tx], MOSFET Q3 is on. MOSFETs Q1 and Q2 perform high-frequency switching to step down Vrec1_min to sinusoidal negative Vac. MOSFET Q2 serves as the main switch, while MOSFET Q1 acts as the synchronous rectifier. Consequently, the duty cycle generated by the control loop should apply to MOSFET Q2.

Another possible control strategy that is slightly different is that (1) the Vrec1 value is regulated to be slightly higher (such as 5% to 20% higher) than the Vac during time period [ta, tb] and time period [tx, ty]; (2) Q1 to Q4 operate at high switching frequency to reduce the Vrec1 to the required Vac. The benefit of this control strategy is that the AC voltage can be tightly controlled and the inverter can provide some reactive current to the AC load.

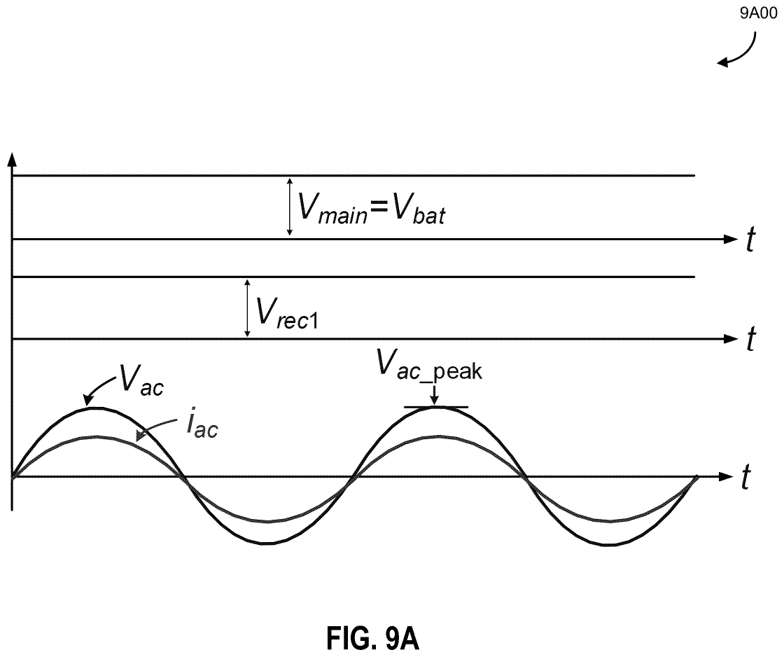

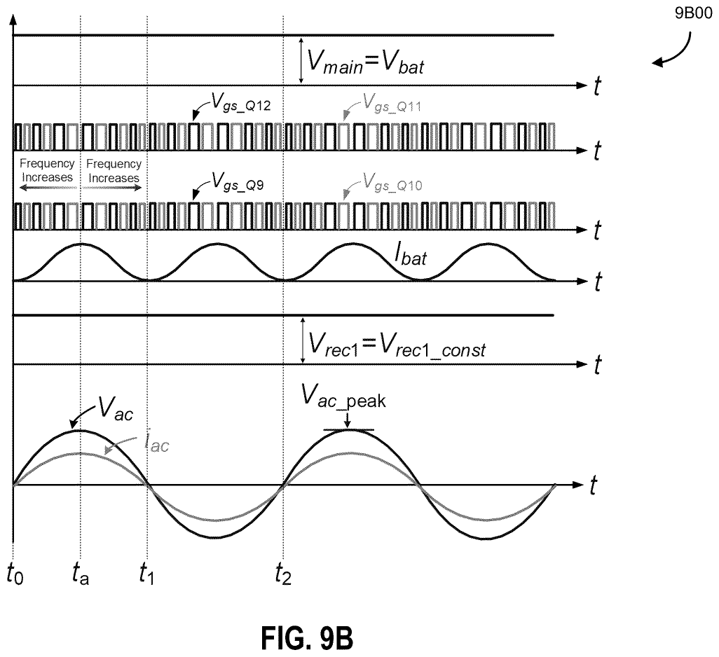

Backward Mode C: In Backward Mode C, the LLC converter regulates the battery voltage Vbat into a constant DC voltage Vrec1_const, as demonstrated in FIG. 9B. In this mode, Q1, Q2, Q3, Q4, Lac, in FIG. 2B form a high-frequency full-bridge inverter circuit, operating within the frequency range of tens to hundreds of kHz (such as 20 to 500 kHz). This circuit modulates the DC voltage Vrec1 into a sinusoidal waveform Vac.

When the load at the AC side is resistive, the output current iac of the full-bridge inverter is in phase with the output AC voltage Vac. It is noted that iac is sourced from the LLC resonant converter (or from the battery end). As depicted in FIG. 9B, the battery current is low when the AC output power is low and increases as the AC output power rises. This implies that the power provided by the battery end dynamically tracks the output power of the AC end, indicating that the double-line frequency ripple current handled by the bus capacitor Cin1 theoretically reaches zero. Consequently, small-sized film capacitors can be employed, significantly enhancing the power density and reliability of the overall system. It is noted that the same conclusion can also be obtained when the AC load is inductive or capacitive.

Conventional unipolar, bipolar, or double-frequency unipolar control methods can all be utilized for AC output voltage control in the high-frequency full-bridge inverter circuit. It is advisable to set Vrec1 as close as possible to the peak voltage of Vac, as this helps to reduce ripple current on Lac, enabling the use of smaller inductance values for Lac. As shown in FIG. 11, the RCC converter 1105 is short-circuited during the operation of the LLC converter 1102 in Backward Mode C. This can be achieved by turning on Q19, Q20, Q21, and Q22 and turning off Q17, Q18, as shown in FIG. 3A. Both the backward operation of the LLC converter 1102 and the operation of the full-bridge inverter 1101 employ voltage mode controllers. It is noted that other control method, such as current mode control, can also be used. The LLC controller circuit 1104 includes a voltage sensor to sample the real-time voltage of Vrec1. Vrec1_Ref represents the reference voltage of Vrec1, which is a pre-set fixed value. Verror2 is the voltage error signal obtained by subtracting Vrec1_FB (output of the voltage sensor) from Vrec1_Ref. Through a voltage loop controller, Verror2 is transformed into Uc2, the control signal of the gate signal generator, which adjusts the gate driving signal in real-time for MOSFETs Q9-Q12. Various control methods, such as Pulse Frequency Modulation (PFM), phase shift modulation, burst mode modulation, and others, can be employed in Gate Signal Generator as shown in FIG. 11 for actual gate driving signal control. Q5, Q6, Q7, Q8 operate as synchronous rectifiers.

The load of the AC output in FIG. 11 is represented by a resistor. In the inverter controller circuit 1103, the AC output voltage, Vac_R, is sampled by a voltage sensor. Vac_R_Ref represents the reference voltage of Vac_R, typically in analog or digital sinusoidal form. Verror1 is the voltage error signal obtained by subtracting Vac_R_FB (output of the voltage sensor) from Vac_R_Ref. Through a voltage loop controller, Verror1 is transformed into Uc1, Voltage Loop Controller produces the control signal, Uc1, to the gate signal generator, which adjusts the gate driving signal in real-time for MOSFETs Q1, Q2, Q3, Q4.

In one embodiment, the RCC converter may be activated during the backward operation of the LLC converter. This is done to leverage Cmain to eliminate the double line frequency ripple current in the battery, which helps reduce internal resistive losses and extend the battery's operational lifespan. The mechanism by which the RCC converter eliminates the double line frequency ripple current on the battery will be elaborated in the following paragraphs, in conjunction with the previously mentioned Backward Mode C operation.

During Backward Mode C operation of the isolated AC-DC stage shown in FIG. 2B, the current on the battery, as illustrated by Ibat in FIG. 9B, contains double line frequency ripple current. This is because the AC side's output power is supplied in real-time by the battery. At times to and t1 in FIG. 9B, the output AC voltage, Vac, is at its zero crossing, resulting in zero instantaneous power and thus, Ibat is also zero. At time ta in FIG. 9B, the output AC voltage Vac and output AC current iac reach 90°, attaining their maximum values, and hence, Ibat also reaches its peak. With the output AC power continuously fluctuating at double line frequency, Ibat likewise fluctuates at the same frequency with a fixed battery voltage. A typical waveform of Ibat is shown in FIG. 9B.

FIG. 9B illustrates the schematic waveforms of the driving signals for MOSFETs Q5-Q8, utilizing the PFM method. Under PFM operation, Q9 and Q10 (Q11 and Q12) are switched at 50% duty and 180 degrees out of phase with each other. From ta to t0, the switching frequency of the LLC converter reduces and from ta to t1, the switching frequency of the LLC converter increases, under the control of the controller shown in FIG. 11. The purpose of this variation of switching frequency is to continuously reduce the input power of the backward LLC converter so as to follow the output AC power.

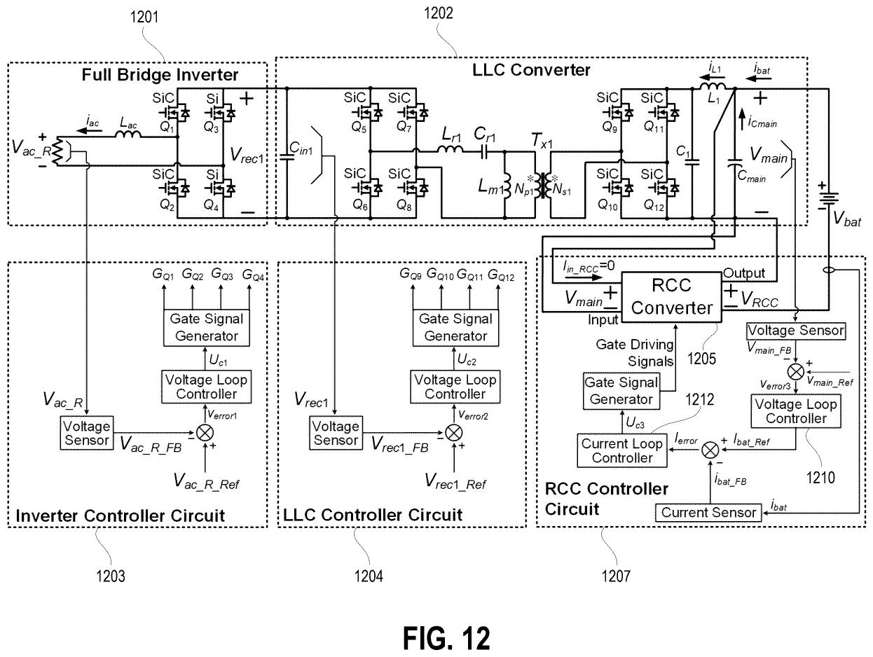

FIG. 12 describes a control diagram for the operation of the isolated AC-DC converter in Backward Mode C as shown in FIG. 2B, wherein the RCC converter 1205 is enabled to eliminate the double line frequency current ripple on Ibat. The following discussion focuses on the RCC controller circuit 1207, as the operation of the inverter controller circuit 1203 and the operation of the LLC controller circuit 1204 are identical to those in FIG. 11, which has been previously discussed.

The starting point is the current waveform of iL1 in FIG. 12, which mirrors the Ibat waveform shown in 9B. This similarity arises from the fact that the input power of the LLC converter should always be equivalent to the output power of the full bridge inverter (assuming ideal components and 100% system efficiency). In FIG. 9B, as the RCC converter is short-circuited, Vbat is directly applied to Cmain. Therefore, the input current of the LLC converter can be considered same as the battery current, Ibat. In FIG. 12, with the RCC converter enabled, the input current of the LLC converter is the sum of the battery current Ibat and the current of Cmain, denoted as iCmain. According to Kirchhoff's current law, iL1=Ibat+iCmain.

In FIG. 12, with the RCC converter 1205 enabled, the input current of the LLC converter (1202), iL1, is the sum of the battery current Ibat, negative value of RCC converter input current Iin_RCC, and the current of Cmain, denoted as iCmain. According to Kirchhoff's current law, iL1=Ibat+iCmain−Iin_RCC.

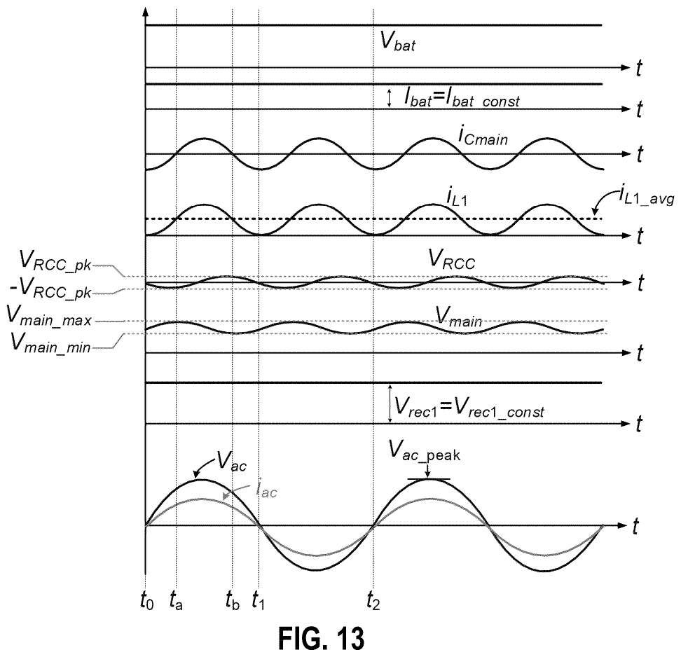

FIG. 13 presents the key waveforms corresponding to the enabled RCC converter during Backward Mode C. In FIG. 13, the time duration from t0 to t2 represents a complete line cycle. From ta to tb, V_{RCC} will be controlled to rise from −V_{RCC}_pk to V_{RCC}_pk in a sinusoidal manner. The average voltage of V_{RCC} is 0. Therefore, in steady-state operation, the actual average output power of the RCC converter 1205 in FIG. 12 is 0. Assuming the system efficiency is 100%, the input current of the RCC converter, Iin_RCC, is 0. Based on this conclusion, the input current of the LLC converter, iL1, in FIG. 12 actually equals the sum of the battery current, Ibat, and the current of Cmain, iCmain, i.e., iL1=Ibat+iCmain.

Since the control objective of the RCC converter is to control Ibat to a constant DC value, the AC component in iL1 is provided by iCmain. FIG. 13 presents the key waveforms corresponding to the enabled RCC converter during Backward Mode C. It can be observed that the waveform of iL1 is identical to the Ibat waveform in FIG. 9B. The double line frequency ripple current in iL1 is entirely provided by iCmain. The DC component in iL1, denoted as iL1_avg, is provided by the battery current Ibat. Therefore, Ibat=Ibat_const=iL1_avg.

Due to the presence of double line frequency ripple current in Cmain, the voltage on Cmain, Vmain, also contains double line frequency ripple voltage. Since VRCC+Vmain=Vbat, and Vbat is a constant DC voltage, the ripple voltage on Vmain and the double line frequency ripple voltage on the RCC converter output voltage VRCC have the same amplitude but differ in phase by 180°, as shown in FIG. 13.

In FIG. 13, the time duration from t0 to t2 represents a complete line cycle. From ta to tb, V_{RCC} will be controlled to rise from −V_{RCC}_pk to V_{RCC}_pk in a sinusoidal manner. This causes the voltage on Vmain to decrease from Vmain_max to Vmain_min in a sinusoidal manner during [ta, tb]. As iCmain=−Cmain*dVmain/dt, a sinusoidal current is generated on iCmain during [ta, tb], which, together with the DC current Ibat, becomes the input current of the LLC converter during backward operation, namely iL1, as shown in box 1202 of FIG. 12. Therefore, it can be concluded that by controlling the voltage on V_{RCC}, it is feasible to control iCmain to generate a sinusoidal current with zero bias, thereby maintaining the battery current Ibat as a constant DC current. In other words, the fluctuation at the double line frequency of AC output power is provided by the energy storage capacitor, Cmain. When iL1 exceeds Ibat_avg (which is same as iL1_avg), iCmain is positive, and when iL1 is below Ibat_const (i.e., iL1_avg), iCmain is negative. Cmain acts as a peak shaving and valley filling element, ensuring that Ibat remains constant as a DC current, and equals to Ibat_const.

It should be pointed out that practical circuits exhibit losses (e.g., conduction losses and switching losses). This results in the input current of the RCC converter 1205, Iin_RCC, in FIG. 12 not being exactly zero. The specific circuit topology of the RCC converter in FIG. 12 is shown in box 3A01 of FIG. 3A. When V_{RCC} outputs a positive voltage, C3 in FIG. 3A will be charged, causing Vlink to increase. Conversely, when VRCC outputs a negative voltage, C3 in FIG. 3A will be discharged, causing Vlink to decrease. Due to the presence of losses (e.g., the switching and conduction losses of Q19-Q22), the average value of Vlink will gradually decrease during the charging and discharging cycles. If the minimum value of Vlink falls below the peak value of the VRCC sinusoidal voltage, the RCC converter will not function properly. Therefore, Q17 and Q18 in FIG. 3A need to perform high-frequency switching actions or operate in burst mode to maintain the average value of Vlink, ensuring proper operation of the RCC converter. Nevertheless, the input current of the RCC converter, Iin_RCC, remains very small (e.g., 0.1 A) because its role is merely to supply energy to C3 in FIG. 3A, compensating for the losses within the RCC converter.

In other words, since the output power of the RCC converter is zero, the input power of the RCC converter will also be zero if there is no loss in RCC Converter (box 3A01 in FIG. 3A). But in real application, the RCC converter will have losses, such as switching losses, conduction losses and magnetic losses. Thus, the input power of the RCC converter equals the losses of the RCC Converter, which is a very small value, typically in the range of 5 W to 20 W. Considering the battery voltage is at 380V, the input current of the RCC converter, Iin_RCC, as shown in box 1207, in FIG. 12, is between 13 mA to 52 mA, which is much smaller than the battery current, ibat, which is in the range of 10 A or more. Therefore, the impact of the input current of the RCC converter, Iin_RCC,_can be neglected.

During the operation of the RCC converter, a typical dual-loop control can be employed, as illustrated in FIG. 12. The controller architecture comprises an outer voltage loop and an inner current loop. The voltage loop aims to stabilize the average value of Vmain based on a predetermined reference voltage Vmain_Ref. Vmain_Ref is an analog or digital representation of the battery voltage and is a DC value. In other words, the goal of the voltage loop controller, as shown as box 1210 in FIG. 12, is to ensure that the average voltage of Vmain equals the battery voltage. Verror3 represents the voltage error signal, calculated by subtracting Vmain_FB (the sampled voltage of Vmain) from Vmain_Ref. Following a voltage loop controller (box 1210), Verror3 is converted into Ibat_Ref, which is the DC reference value for the current loop controller (box 1212). Since Vmain contains double line frequency ripple voltage (120 Hz in North America and 100 Hz in Europe, China), the voltage loop controller (1210) should remove this double like frequency component. One way to remove the double line frequency ripple is to use a low pass filter with small bandwidth, such as 10 Hz. Another way to remove the double line frequency is to use a digital notch filter to block the double line frequency.

The current loop controller (1212) aims to regulate the battery output current to a constant DC value. Ierror represents the current error signal, obtained by subtracting ibat_FB from Ibat_Ref. Following a current loop controller (1212), Ierror is converted into Uc3, which serves as the control signal for the gate signal generator responsible for converting the Uc3 signal into the gate driving signals of the MOSFETs in the RCC converter so that the RCC converter will generate the required voltage, VRCC, which has the same magnitude as the ripple voltage of Vmain and is reverse in phase so that Vmain+VRCC does not contain any ripple and a DC current flows through battery.

The above discussion assumes that the AC load is a resistor. When the AC load is inductive or capacitive, similar control strategies can also be used. The details are not repeated here.

If the bidirectional AC to DC rectifier (box 1201 as shown in FIG. 12) is connected to the AC grid, the control strategies describe above can also be applied. The details are not repeated here.

In some embodiments, the method steps disclosed above for controlling the operation of the first AC-DC power stage that can be used bi-directionally may be stored as machine interpretable instruction sets within a non-transitory computer readable medium. The machine interpretable instructions may be capable of causing a processor to perform the method steps discussed above.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

1. An AC to DC rectifier power circuit device for bi-directional operation providing power to an energy storage component, the AC to DC rectifier power circuit device comprising:
a first AC-DC power stage comprising:
a front-stage totem-pole bridgeless rectifier configured for rectifying a sinusoidal input voltage Vac into a half-wave sinusoidal voltage, Vrec1, with a fixed peak voltage, the front-stage totem-pole bridgeless rectifier including a capacitor Cin coupled to an output of the front-stage totem-pole bridgeless rectifier and configured to filtering a switching frequency ripple;
a back-stage converter coupled to the front-stage totem-pole bridgeless rectifier across the capacitor Cin and configured to achieve power factor correction (PFC) operation of the front-stage totem-pole bridgeless rectifier, the back-stage converter controlling an AC input current Iac corresponding to the sinusoidal input voltage Vac; and
a controller circuit coupled to a voltage sensor for measuring the sinusoidal input voltage Vac, and controlling operation of the AC to DC rectifier power circuit device in either: (i) an active bridge mode when the sinusoidal input voltage Vac is at or higher than a target nominal voltage, and (ii) a boost mode when the sinusoidal input voltage Vac is less than a target nominal voltage, the boost mode effectively regulating an output voltage of the front-stage totem-pole bridgeless rectifier to be higher than the input voltage, reducing switching losses for operation of the front-stage totem-pole bridgeless rectifier;
wherein the front-stage totem-pole bridgeless rectifier includes a high frequency switching leg having switches Q1 and Q2, and a line-frequency switching leg having witches Q3 and Q4, and in the boost mode operation, when Vac is in a positive half-cycle, a duty cycle is applied to Q2, and Q4 is turned on while Q3 is turned off, and when Vac is in a negative half-cycle, the duty cycle is applied to Q1 and Q3 is turned on while Q4 is turned off the duty cycle remaining constant over each line cycle.

2. (canceled)

3. (canceled)

4. The AC to DC rectifier power circuit device of claim 1, further comprising a ripple cancellation converter circuit (RCC) connected in series with an output of the first AC-DC power stage, the RCC configured to generate a same magnitude but 180-degree phase shifted ripple voltage V_{RCC} to reduce a double line frequency ripple.

5. The AC to DC rectifier power circuit device of claim 4, wherein the RCC is controlled using a separate control loop than the first AC-DC power stage, and during reverse operation of the first AC-DC power stage, the RCC is short circuited.

6. The AC to DC rectifier power circuit device of claim 1, further comprising at least one additional circuit phase configured to add additional power during forward operation of the AC to DC rectifier power circuit device, and during backward operation of the AC to DC rectifier power circuit device, only the first AC-DC power stage operates to provide power in a reverse direction.

7. The AC to DC rectifier power circuit device of claim 1, further comprising at least one additional circuit phase configured to add additional power during forward operation of the AC to DC rectifier power circuit device, and during backward operation of the AC to DC rectifier power circuit device, only the first AC-DC power stage operates to provide power in a reverse direction and the at least one additional circuit phase are not utilized.

8. The AC to DC rectifier power circuit device of claim 7, wherein the at least one additional circuit phase include at least one of a diode rectifier circuit phase.

9. The AC to DC rectifier power circuit device of claim 1, wherein the energy storage component is at least one of a battery, a capacitor, a super capacitor, a power bank, or a portable power station.

10. The AC to DC rectifier power circuit device of claim 1, wherein the sinusoidal input voltage Vac is provided from a power grid, and during forward operation, the power grid provides power to the energy storage component, and during backwards operation, the energy storage component provides power to the power grid.

11. The AC to DC rectifier power circuit device of claim 2, wherein the controller circuit is configured to establish PFC through control of an input current of the back-stage LLC DC to DC converter to be a half sinusoidal waveform.

12. The AC to DC rectifier power circuit device of claim 11, wherein a current Irec1 is sensed and compared with a reference current Iref and the controller circuit generates a switching frequency signal so that Irec1 is a rectified sinusoidal waveform.

13. The AC to DC rectifier power circuit device of claim 11, wherein the AC input current lac is sensed and compared with a reference current Iref_B, and the controller circuit generates a switching frequency signal to switches of the front-stage totem-pole bridgeless rectifier such that Iac is a sinusoidal waveform, wherein Iref_B is determined based at least on an output of a voltage error amplifier.

14. The AC to DC rectifier power circuit device of claim 13, wherein the voltage error amplifier produces a peak value of a reference current, Iref_B_pk.

15. The AC to DC rectifier power circuit device of claim 2, wherein in the active bridge mode, all switches of the front-stage totem-pole bridgeless rectifier operate at line frequency to form an active bridge.

16. The AC to DC rectifier power circuit device of claim 1, wherein to achieve the PFC operation, an input current is required to be sinusoidal in phase with the sinusoidal input voltage Vac, and the instantaneous power Pac is determined using a relation:
$${P}_{a c} ( θ ) = \sqrt{2} {V}_{ac \_ rms} sin θ \cdot \sqrt{2} {I}_{in \_ rms} sin θ = 2 {P}_{i n} {sin}^{2} θ$$
wherein Pᵢₙ is defined as input active power;
wherein Vac_rms is defined as the RMS value of the AC input voltage;
wherein I_{in_rms} is defined as the RMS value of the AC input current; and
wherein θ is defined as a phase angle that ranges between 0 and 180 degrees.

17. The AC to DC rectifier power circuit device of claim 1, wherein switches of the front-stage totem-pole bridgeless rectifier are silicon carbide switches.

18. The AC to DC rectifier power circuit device of claim 1, wherein the AC to DC rectifier power circuit device is utilized to couple a power grid and an electric vehicle, and the energy storage component is a battery of the electric vehicle.

19. The AC to DC rectifier power circuit device of claim 1, where the AC to DC rectifier power circuit device is either incorporated as a first power stage of a power transfer circuit or operated as a standalone power transfer circuit.

20. The AC to DC rectifier power circuit device of claim 1, where the capacitor Cin has a capacitance of less than about 10 microfarads.

21. A method for bi-directional operation of an AC to DC rectifier power circuit comprising a first AC-DC power stage for providing power to an energy storage component, the method comprising:
rectifying, through a front-stage totem-pole bridgeless rectifier, a sinusoidal input voltage Vac into a half-wave sinusoidal voltage, Vrec1, with a fixed peak voltage, the front-stage totem-pole bridgeless rectifier including a capacitor Cin coupled to an output of the front-stage totem-pole bridgeless rectifier and configured to filtering a switching frequency ripple;
achieving, through a back-stage converter, a power factor correction (PFC) operation of the front-stage totem-pole bridgeless rectifier, the back-stage converter controlling an AC input current Iac corresponding to the sinusoidal input voltage Vac; and
measuring, using a controller circuit coupled to a voltage sensor the sinusoidal input voltage Vac, and controlling operation of the AC to DC rectifier power circuit device in either: (i) an active bridge mode when the sinusoidal Vac is at or higher than a target voltage, and (ii) a boost mode when the sinusoidal input voltage Vac is less than a target nominal voltage, the boost mode effectively regulating an output voltage of the front-stage totem-pole bridgeless rectifier to be higher than the input voltage, reducing switching losses for operation of the front-stage totem-pole bridgeless rectifier;
wherein the front-stage totem-pole bridgeless rectifier includes a high frequency switching lea having switches Q1 and Q2, and a line-frequency switching leg having switches Q3 and Q4, and in the boost mode operation, when Vac is in a positive half-cycle, a duty cycle is applied to Q2, and Q4 is turned on while Q3 is turned off, and when Vac is in a negative half-cycle, the duty cycle is applied to Q1 and Q3 is turned on while Q4 is turned off, the duty cycle remaining constant over each line cycle.

22. (canceled)

23. (canceled)

24. The method of claim 21, further comprising a ripple cancellation converter circuit (RCC) connected in series with an output of the first AC-DC power stage, the RCC configured to generate a same magnitude but 180-degree phase shifted ripple voltage V_{RCC} to reduce a double line frequency ripple.

25. The method of claim 24, wherein the RCC is controlled using a separate control loop than the first AC-DC power stage, and during reverse operation of the first AC-DC power stage, the ROC is short circuited.

26. The method of claim 21, further comprising at least one additional circuit phase configured to add additional power during forward operation of the AC to DC rectifier power circuit device, and during backward operation of the AC to DC rectifier power circuit device, only the first AC-DC power stage operates to provide power in a reverse direction.

27. The method of claim 21, further comprising at least one additional circuit phase configured to add additional power during forward operation of the AC to DC rectifier power circuit device, and during backward operation of the AC to DC rectifier power circuit device, only the first AC-DC power stage operates to provide power in a reverse direction and the at least one additional circuit phase are not utilized.

28. The method of claim 27, wherein the at least one additional circuit phase include at least one of a diode rectifier circuit phase.

29. The method of claim 21, wherein the energy storage component is at least one of a battery, a capacitor, a super capacitor, a power bank, or a portable power station.

30. The method of claim 21, wherein the sinusoidal input voltage Vac is provided from a power grid, and during forward operation, the power grid provides power to the energy storage component, and during backwards operation, the energy storage component provides power to the power grid.

31. The method of claim 22, wherein the controller circuit is configured to establish PFC through control of an input current of the back-stage LLC DC to DC converter to be a half sinusoidal waveform.

32. The method of claim 31, wherein a current Irec1 is sensed and compared with a reference current Iref and the controller circuit generates a switching frequency signal so that Irec1 is a rectified sinusoidal waveform.

33. The method of claim 31, wherein the AC input current Iac is sensed and compared with a reference current Iref_B, and the controller circuit generates a switching frequency signal to switches of the front-stage totem-pole bridgeless rectifier such that Iac is a sinusoidal waveform, wherein Iref_B is determined based at least on an output of a voltage error amplifier.

34. The method of claim 33, wherein the voltage error amplifier produces a peak value of a reference current, Iref_B_pk.

35. The method of claim 22, wherein in the active bridge mode, all switches of the front-stage totem-pole bridgeless rectifier operate at line frequency to form an active bridge.

36. The method of claim 21, wherein to achieve the PFC operation, an input current is required to be sinusoidal in phase with the sinusoidal input voltage Vac, and the instantaneous power Pac is determined using a relation:
$${P}_{a c} ( θ ) = \sqrt{2} {V}_{ac \_ rms} sin θ \cdot \sqrt{2} {I}_{in \_ rms} sin θ = 2 {P}_{i n} {sin}^{2} θ$$
wherein Pᵢₙ is defined as input active power;
wherein V_{ac_rms} is defined as the RMS value of the AC input voltage;
wherein I_{in_rms} is defined as the RMS value of the AC input current; and
wherein θ is defined as a phase angle that ranges between 0 and 180 degrees.

37. The method of claim 21, wherein switches of the front-stage totem-pole bridgeless rectifier are silicon carbide switches.

38. The method of claim 21, wherein the AC to DC rectifier power circuit device is utilized to couple a power grid and an electric vehicle, and the energy storage component is a battery of the electric vehicle.

39. The method of claim 21, where the AC to DC rectifier power circuit device is either incorporated as a first power stage of a power transfer circuit or operated as a standalone power transfer circuit.

40. The method of claim 21, where the capacitor Cin has a capacitance of less than about 10 microfarads.

41. A non-transitory computer readable medium, storing machine interpretable instruction sets, which when executed by a processor, cause the processor to perform a method for providing power to an energy storage component, the method comprising:
rectifying, through a front-stage totem-pole bridgeless rectifier, a sinusoidal input voltage Vac into a half-wave sinusoidal voltage, Vrec1, with a fixed peak voltage, the front-stage totem-pole bridgeless rectifier including a capacitor Cin coupled to an output of the front-stage totem-pole bridgeless rectifier and configured to filtering a switching frequency ripple;
achieving, through a back-stage converter, a power factor correction (PFC) operation of the front-stage totem-pole bridgeless rectifier, the back-stage converter controlling an AC input current Iac corresponding to the sinusoidal input voltage Vac; and
measuring, using a controller circuit coupled to a voltage sensor, the sinusoidal input voltage Vac, and controlling operation of the AC to DC rectifier power circuit device n either: (i) an active bridge mode when sinusoidal input voltage Vac is at or higher than a target nominal voltage, and (ii) a boost mode when the sinusoidal input voltage Vac is less than a target nominal voltage, the boost mode effectively regulating an output voltage of the front-stage totem-pole bridgeless rectifier to be higher than the input voltage, reducing switching losses for operation of the front-stage totem-pole bridgeless rectifier;
wherein the front-stage totem-pole bridgeless rectifier includes a high frequency switching leg having switches Q1 and Q2, and a line-frequency switching leg having switches Q3 and Q4, and in the boost mode operation, when Vac is in a positive half-cycle, a duty cycle is applied to Q2, and Q4 is turned on while Q3 is turned off, and when Vac is in a negative half-cycle, the duty cycle is applied to Q1 and Q3 is turned on while Q4 is turned off, the duty cycle remaining constant over each line cycle.

42-68. (canceled)
